(19) United States
(12) Patent Application Publication
(10) Pub. No.: US 2005/0049903 A1
(43) Pub. Date: Mar. 3, 2005

(54) Method and system for computer aided management of time & financial data

(76) Inventor: Ramkumar N. Raja, Milpitas, CA (US)

Correspondence Address: ORRICK, HERRINGTON & SUTCLIFFE, LLP, 4 PARK PLAZA, SUITE 1600, IRVINE, CA, 92614-2558, US

(21) Appl. No.: 10/675,048

(22) Filed: Sep. 29, 2003

Related U.S. Application Data
(62) Division of application No. 09/452,898, filed on Dec. 1, 1999.

(51) Int. Cl. G06F 17/60

(52) U.S. Cl. 705/7

(57) ABSTRACT

A method and system for contract based finance and time management is disclosed. The system establishes contract and project guidelines, gathers expense data, gathers time data, analyzes expense and time data within contract and project guidelines, routes expense data and routes time data. The system provides an intuitive and simple interface for entry of time and expense data as well as simplifies managerial and accounting tasks.

### FIELD OF THE INVENTION

The present invention relates to the field of computer systems for managing financial and time data. In particular the present invention discloses a system and method for contract based management of financial and time data as for consulting projects.

### BACKGROUND OF THE INVENTION

Clients often hire companies to complete projects. The companies often have a vast number of resources such as employees and subcontractors to manage. These employees are typically directed by the company's managers. The client's projects may be simple and only require a few hours of labor from one single employee. In this case, for the hired company, billing the client and managing the employee's time are not too complex. However, projects are often quite complex and require the dedication of a vast number of the company's resources to complete the project. It is critical for the company to efficiently integrate its resources in order to maximize the productivity and profitability of the company. In addition, performance measurement data analysis allows companies to identify and avoid less profitable types of projects.

For example the client's project may be quite complex and require the company to dedicate 100 employees to the project for 2 years. However, the complexity increases when 100 employees are dedicated to the single project and another 50 employees work on the project half of their time and another handful of employees are working on multiple projects for various clients. Managing these resources becomes quite difficult.

Current systems of tracking and managing employee's time and expenses begin at the employee level. An employee typically submits the amount of time and expenses incurred while working on a project to a manager who approves or disapproves the time and then the client is billed. This method requires employees to generate daily, weekly or monthly time and expense sheets for each separate project, which is highly inefficient. A new approach is required that integrates time and financial information on an employee basis across projects on single time or expense sheets. At the same time, these sheets are electronically separated by project for routing to the approving managers and appropriate accounting clerks for invoicing and payments. The invoicing, approval routing, cost, expense, and revenue calculations are controlled by the contract and project parameters.

### SUMMARY OF THE INVENTION

The present invention provides a method and system of contract based management of employee and resource time and expenses. In one embodiment the system establishes contract and project guidelines, gathers expense data; gathers time data, analyzes expense and time data within contract and project guidelines, routes expense data and routes time data for managerial approval and financial processing.

Other objects, features, and advantages of present invention will be apparent from the company drawings and from the following detailed description.

### BRIEF DESCRIPTION OF THE DRAWINGS

The objects, features and advantages of the present invention will be apparent to one skilled in the art in view of the following detailed description in which:

FIG. 1 is a flow chart describing the inventions application from contract formation through project development, until final accounting and analysis.

FIG. 2 is one embodiment of a Resource Timesheet entry interface for an employee across multiple projects or tasks.

FIG. 3 is a flow chart describing the routing of a generic Timesheet.

FIG. 4 is one embodiment of a Resource Expense Sheet entry interface for an employee across multiple projects and cost centers.

FIG. 5 is a flow chart describing the routing of a generic Expense Sheet.

FIG. 6A is one embodiment for a contract setup interface for assigning administrators.

FIG. 6B is one embodiment for a contract setup interface for tracking professional time.

FIG. 6C is one embodiment for a contract setup interface for establishing invoice processing rules.

FIG. 6D is one embodiment for a contract setup interface for establishing expensing rules.

FIG. 6E is one embodiment for a contract setup interface for establishing Billing information.

FIG. 6F is one embodiment for a contract setup interface for establishing overtime guidelines.

FIG. 7A is one embodiment for a project setup interface for assigning project managers to a project.

FIG. 7B is one embodiment for a project setup interface for assigning Resources and Client managers to projects.

FIG. 7C is one embodiment for a project setup interface for mapping Tasks to Projects.

FIG. 8 is one embodiment for a Resource setup interface for entering and altering Resource information.

FIG. 9 is one embodiment of a Manager's Approval screen demonstrating Work-Flow numbers.

FIG. 10 is one embodiment of an Invoice Generating screen.

FIG. 11A is one embodiment of a timesheet Notes Entry interface.

FIG. 11B is one embodiment of an Expense Notes Entry interface.

FIG. 12A is one embodiment of a company setup interface for establishing company details.

FIG. 12B is one embodiment of a company setup interface for establishing timesheet details.

FIG. 13 is one embodiment of a Timesheet Approval Summary interface for approving time entries.

FIG. 14 is one embodiment of an e-mail reminder interface.

FIG. 15 is one embodiment for a cost center setup interface for assigning cost center managers and Accounts payable administrators.

FIG. 16 is one embodiment for an expense sheet summary interface for viewing and submitting multiple expenses entered on a sub-screen.

FIG. 17 is one embodiment for an expense type setup interface.

FIG. 18 is one embodiment for an expense sheet approval interface.

FIG. 19 is one embodiment for an expense sheet correction interface.

FIG. 20 is one embodiment of a performance report generated by the present system.

### DETAILED DESCRIPTION

A method and system for contract based finance and time management is disclosed. In the following description, for purposes of explanation, specific nomenclature is set forth to provide a thorough understanding of the present invention. However, it will be apparent to one skilled in the art that these specific details are not required in order to practice the present invention. By way of example only, the present invention has been described with reference to client/consultant/employee (resource) relationship defined by contract and project parameters. However, the same techniques can easily be applied to other types of relationships where time keeping and financial data integration is beneficial.

The figures are solely intended to clarify embodiments of the present system. One may deviate from the figures and remain within the spirit and scope of the present system.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The following description of the system includes a discussion of these relationships which is followed by a description of the system components as applied to these relationships.

### Company/Client Contract Level

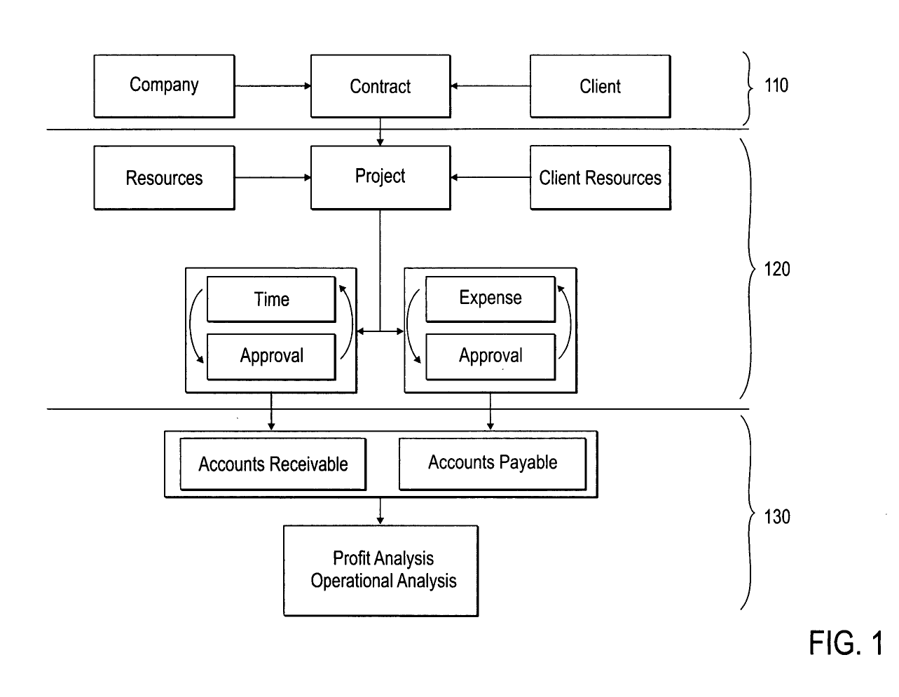

Referring to FIG. 1, the basic structure of a contract based time and financial data management system must account for multiple levels of management from the client/company level (110) to the manager/employee (resource) level (120) to the Accounting level (130). The management system must be flexible enough to work with any type of client/company project yet be rigid enough to maintain consistent parameters for every project.

The first parameters that define the management system are determined when a client hires a company to complete a project (110). This usually occurs between executives of the company and the client. At this time certain contract guidelines are established such as company, operation's and control's controlling system parameters. For example the client and company will establish some or all of the following: the price the client will pay the company for completing the project; the rate of monetary billing and the base rate; such as dollars per hour, day or week per a resource's role or task, the number of hours the company's employees will spend on the project; and the number of days the project will take for completion. The contract may also state many other situations where client approval is required.

### Management/Resource Level

Once the parameters of the project are determined at the Company/Client level. the company's managers have the task of managing its resources to meet its contractual obligations to the client (120). This requires the managers to staff the project with employees (resources) of suitable experience; oversee the resource's progress. approve or disapprove the time and expenses the resources spend on the project; attain the client's approval or disapproval for parameters determined at the Company/Client level; and submit all approved time to the accounting department for invoicing. There are many levels to the manager's approval or disapproval of the time and expenses of resources as dictated by the specific contract parameters. The manager must consider an employee's vacation time, sick time, straight time and/or overtime. The complexity of the managers' responsibilities increases exponentially with each additional project the manager handles. The complexity further increases when multiple managers oversee only parts of projects or multiple managers oversee the same part of a project.

### Accounting Level

Once the managers have approved the resource's time, the financial and time data can be provided to the Accounting department in the form of hours that the system may potentially bill per the contract parameters. The system aids the accounting personnel in the selection and summation of billables into invoices. The system ensures the billable hours are summarized per the contract parameters, then the invoices may be sent to the client (130). The financial and time data may also be analyzed to determine whether operational goals have been met such as completing the project under budget, or within time constraints. Thus, the present invention will integrate all the levels of financial and time management described above through a project/contract based financial system.

### System Components

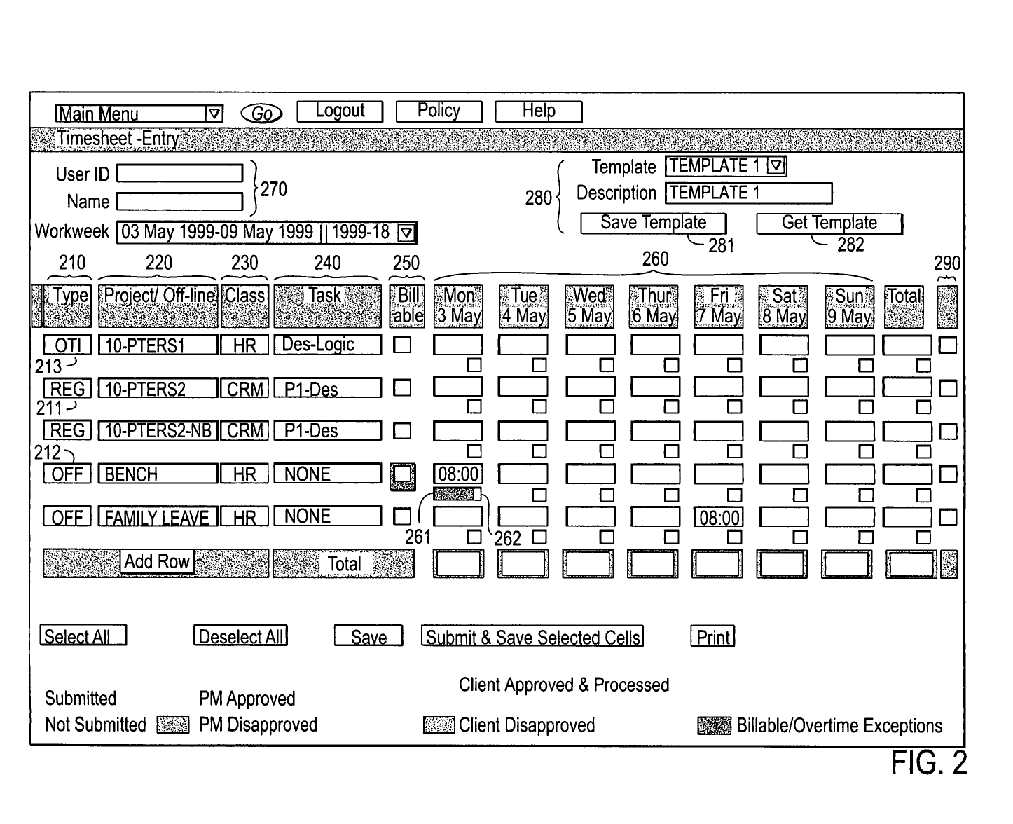

In one embodiment, the Resource enters time data and expense data separately. Referring to FIG. 2, all time for a week (260) is entered by a Resource (270) into a single Timesheet and then the system routes the entries to the appropriate approving Project, Client and Cost Center Managers. A cost center manages any non-billable time and expense processing. Cost centers serve at least three significant functions. First, each resource is assigned to a cost center and a cost center manager approves the resource's off-time timesheet entries. Secondly, the cost center is a collection point for all standard costs not directly associated with a project. Finally, the cost center's accounts payable clerk reimburses resources for approved expense sheets.

Each Resource's individual Timesheet is structured per Company, Operation and Contract controlling system parameters. With the exception of the actual number of hours and the associated Notes, all other timesheet entries are dropdowns driven by the controlling parameters and their Effectivity To-From Dates. Type (210), Project/off-time (220), class (230), and task (240) categories and Billable Flags (250) are available to the Resource and most often the desired entries are defaulted. This time data allows the invoicing of approved time despite the fact that not all the hours in a timesheet have been approved. The time data also allows a single timesheet to be routed to multiple approving managers per contract and project parameters.

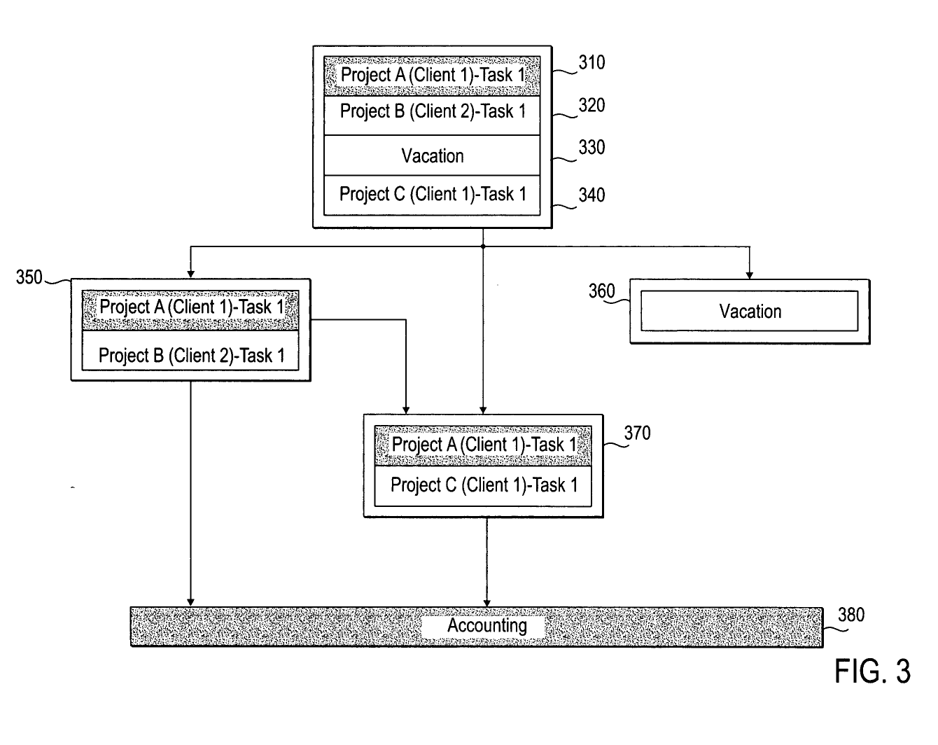

FIG. 3 shows how various entries from a Resource's timesheet are split up and routed for approval. Project A (310) requires both Project Manager and Client approval. Thus, it is first routed for Manager approval (350) and then for Client approval (370). Project B (320) requires Project Manager approval only so it is routed directly for the Manager's approval (350). Vacation (330) is routed for Off-Time approval (360). Finally Project C (340) requires Client approval only and is directed immediately for Client approval (370). All entries reach Accounting (380) after being properly approved and calculated per the contract parameters.

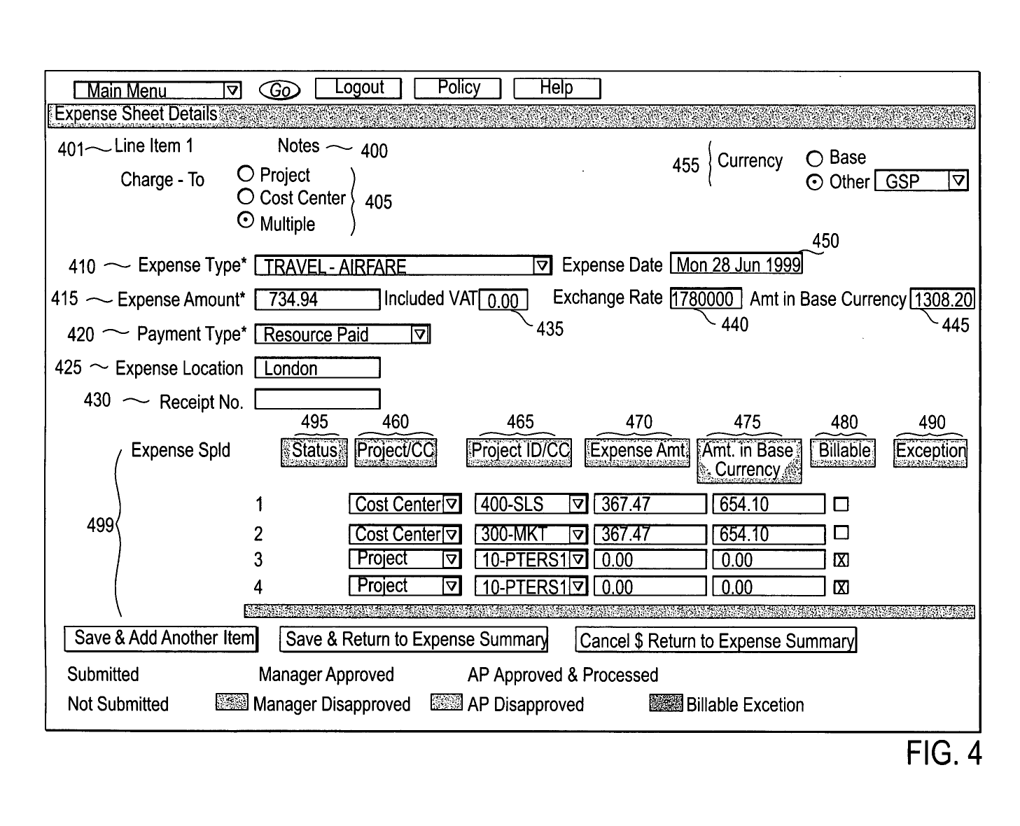

Referring to FIG. 4, all expenses are entered by a Resource into a single Expense Sheet and then the system routes the entries to the appropriate approving Project and/or Cost Center Managers. Each Resource's individual Expense sheet is structured per Company, Operation and Contract controlling system parameters. With the exception of the actual Expense Amounts (415), Exchange Rates (440), VAT (435), Location(425), Receipt Number (430) and Notes (400), all other Expense Sheet entries are dropdowns driven by the controlling parameters and their Effectivity To-From Dates. Expense Type (410), Payment Type (420), Expense Date (450), Project/CC (460) and Project ID/CC (465) categories and Billable Flags (480) are available to the Resource and most often the desired entries are defaulted. This expense data allows a single expense sheet to be routed to multiple approval managers per company and contract parameters.

The Expense Sheet Entry allows expenses to be split between multiple Projects or Cost Centers (499). With the Expense-Split feature an extended trip can be split amongst the projects and/or cost centers that benefited on a single expense sheet. For example. airfare could be split between two different projects located at the trip's destination, while lodging and meals for the first two days of the trip can be charged to the first project, while the lodging and meals for the third day can be charged to the second project. When submitted, the system separates the expenses and routes the entries to appropriate approving Project, Client and Cost Center Managers and then on to the Accounting Manager for invoicing and payment.

The Foreign Currency feature allows the user to identify the Country (425), the foreign currency (455), the exchange rate (440) and the Amount in Base Currency (445). The system also allows the entry of the Value Added Tax (VAT) amount (435). To manage business in the European Market the system keeps track of VAT (Value Added Taxes) associate with each expense. The VAT amount is entered per Expense and the system produces periodic reports as required to obtain refunds from the government agencies. Then based on the exchange rate (440), and the Payment Type (420) (Resource Paid, Company Credit Card, Company Prepaid, Client Prepaid) the system displays how much each individual or organization was charged.

After the first Expense Sheet line item is entered, the system retains those entries to facilitate the entry of the next line item. As the line items are entered, this data updates the default-data. This way, after the first line item, the minimum amount of information needed for most line items will be, the Expense Type from the dropdown list and the expense amount.

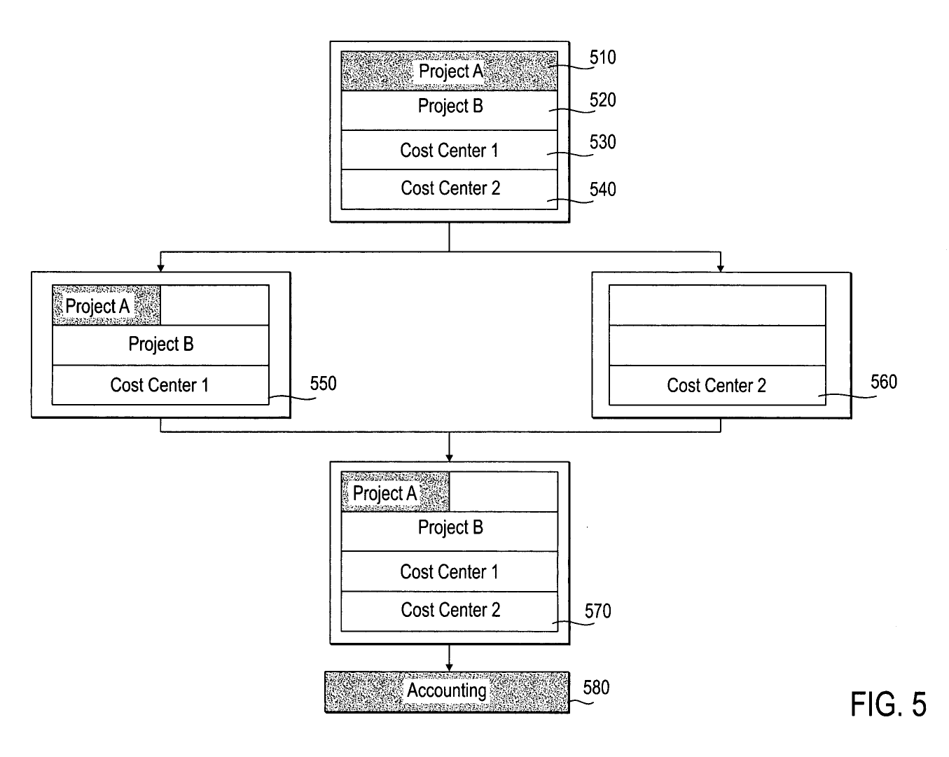

FIG. 5 shows how various entries from a Resource's Expense Sheet are split up and routed for approval. Project A (510), Project B (520) and Cost Center 1 (530) require Project Manager approval. Thus, it is routed for the Project Manager's approval (550). Cost Center 2 (540) requires Cost Center Manager approval only so it is routed directly for the Cost Center Manager's approval (560). All entries then are routed for Accounts Payable Approval (570) and then reach Accounting (580) for invoice and reimbursement payment processing

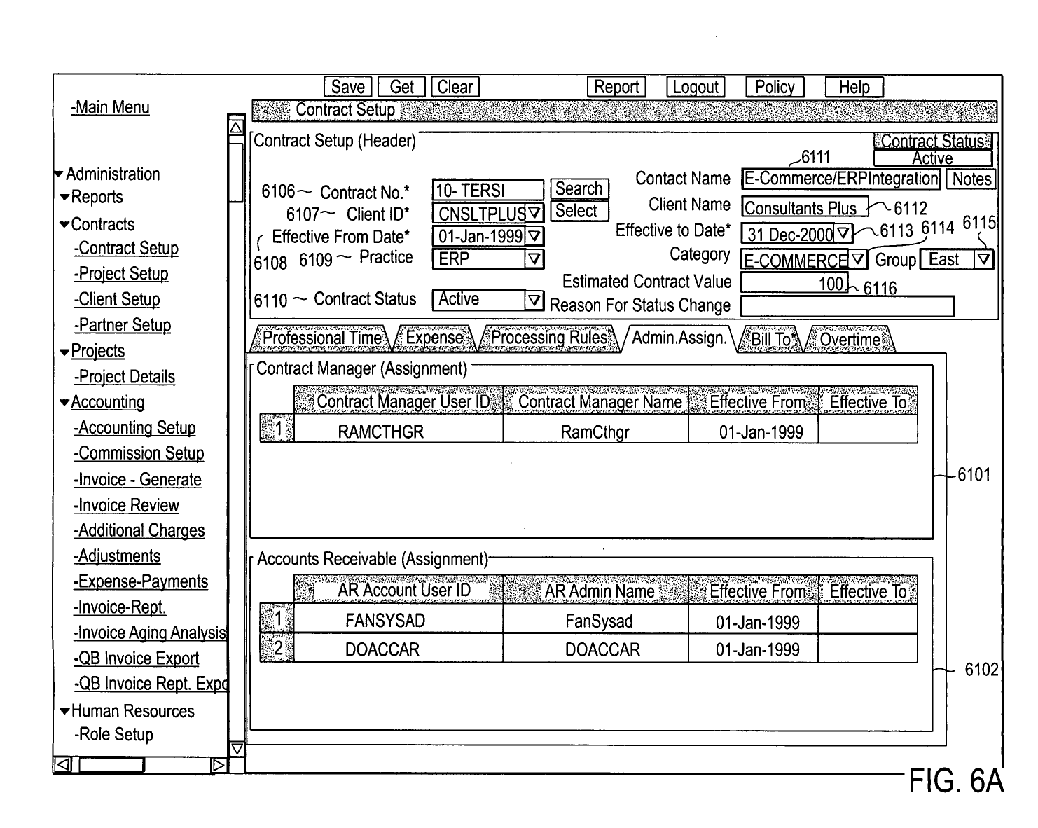

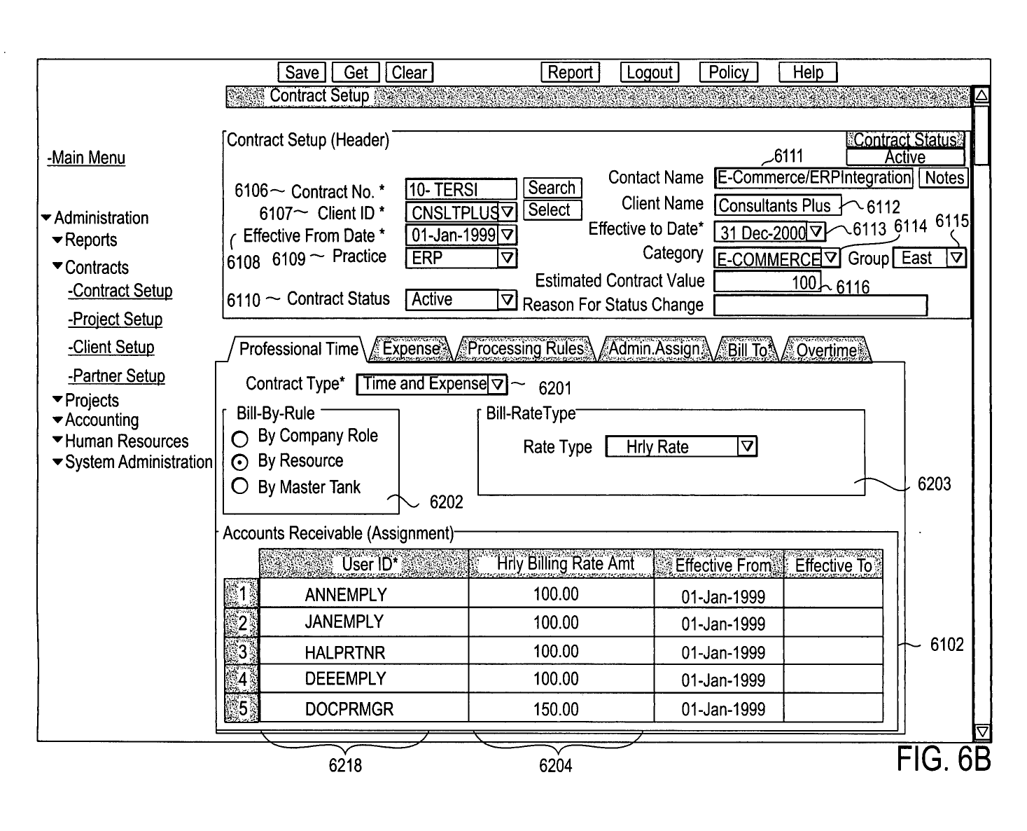

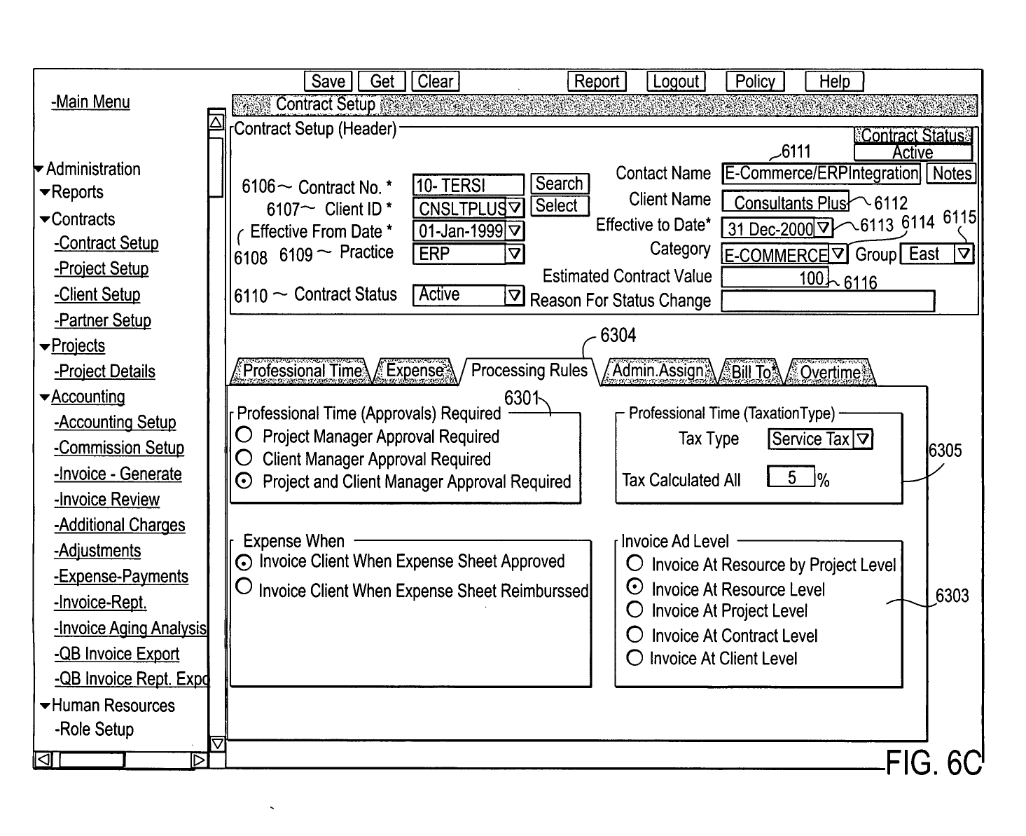

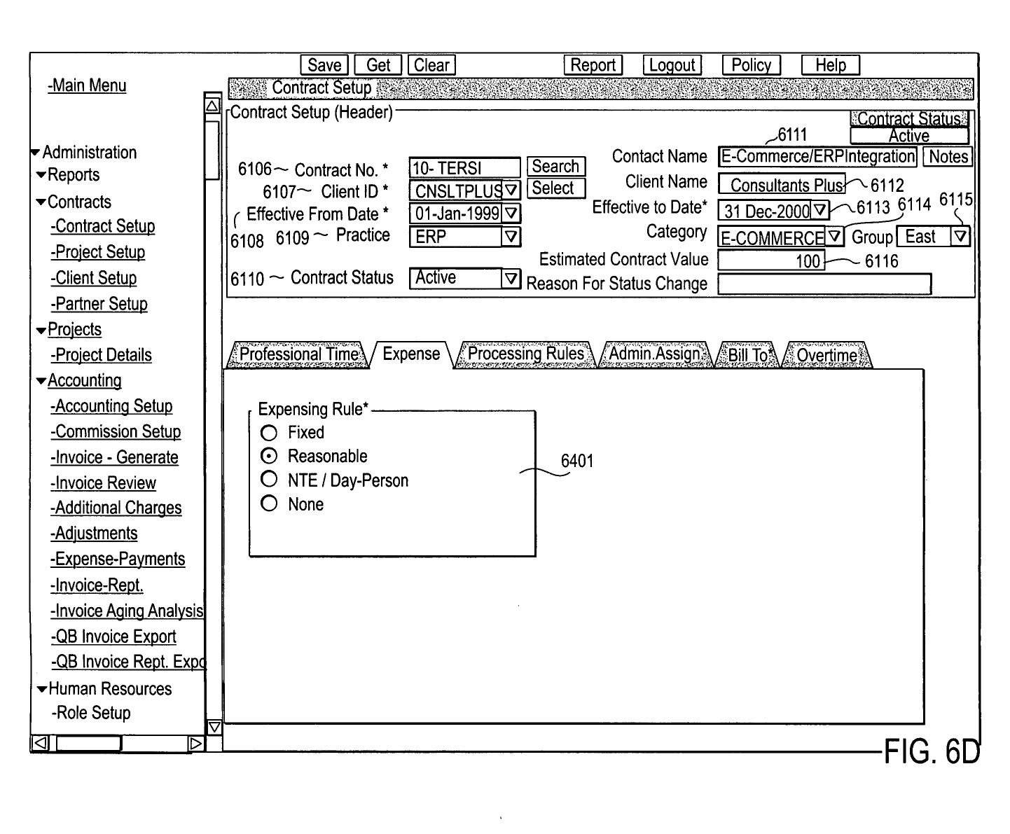

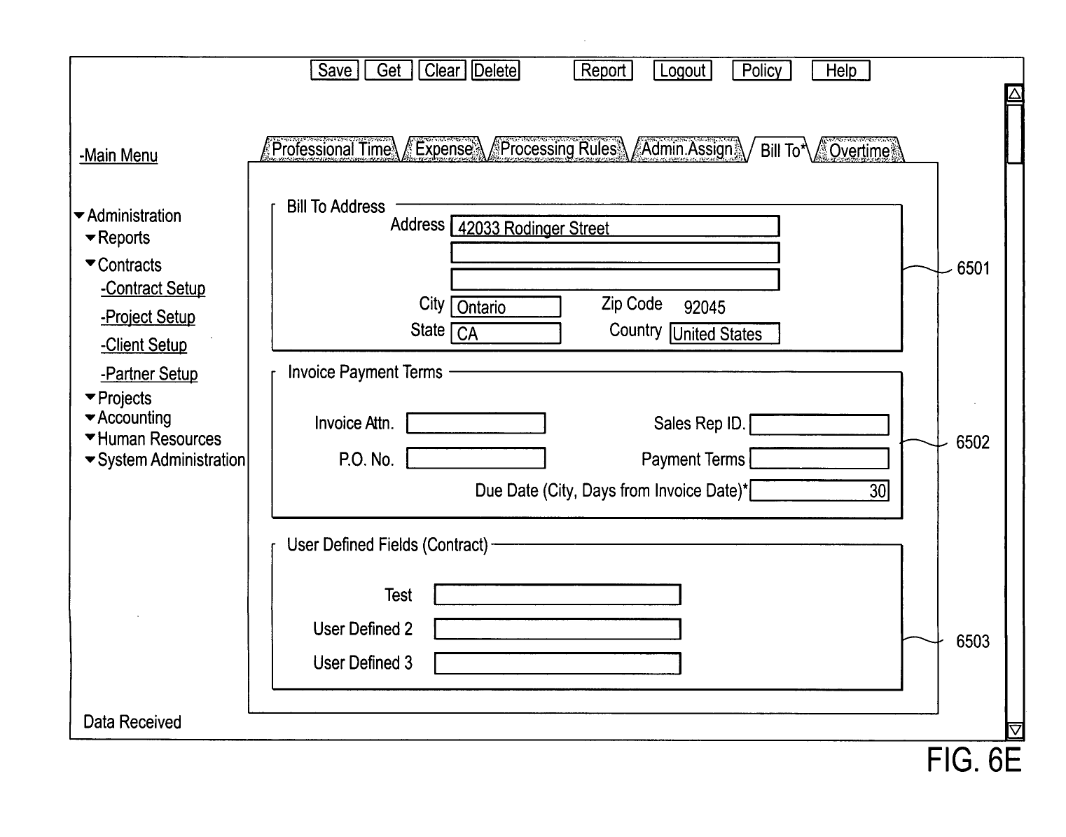

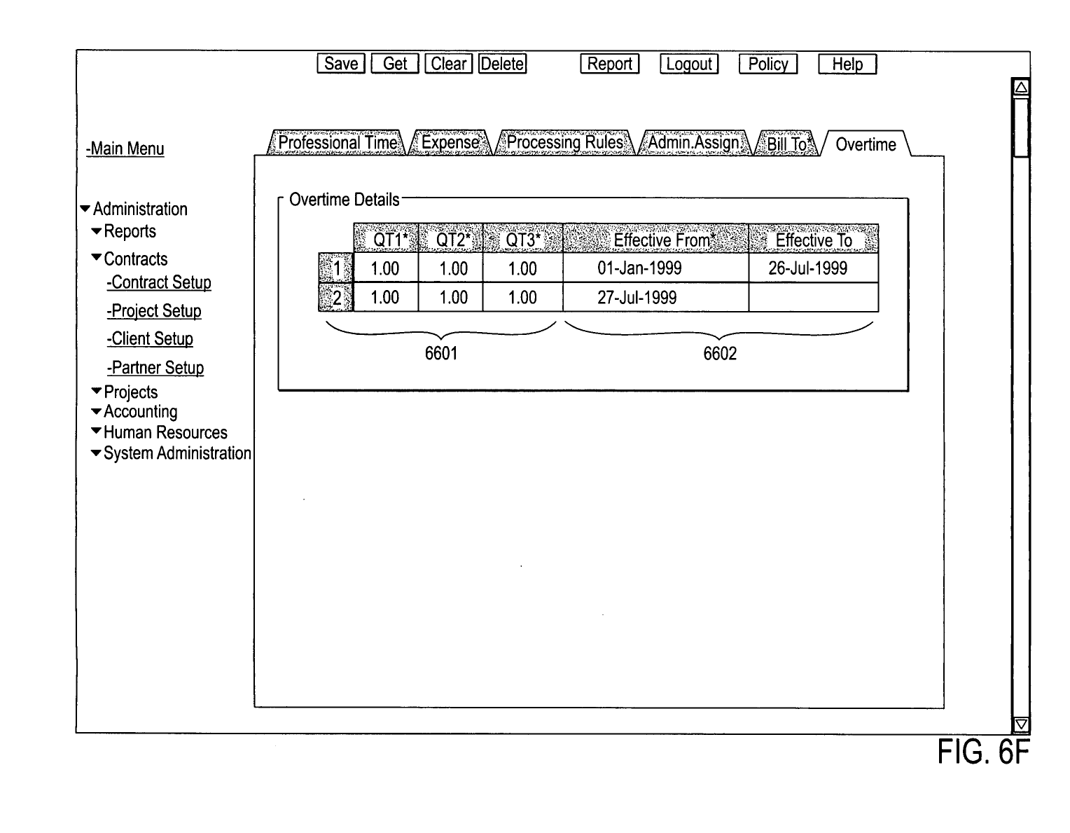

Referring to FIG. 6A, the Contractual Setup parameters dictate which manager(s) will be required and have access to approving the timesheet entries (6101). The instant the Resource has submitted the hours, the hours are flagged for the manager in the Workflow-Numbers (901) located to the right of each screen title on the manager's Main Menu. The system works on an exception-basis so managers only see those entries that are waiting for his or her action. The manager can approve the hours on a summary level or approve/disapprove the hours on a detailed (Project/Task/Billable-Nonbillable/Date) level. Disapproved time and their explanatory notes, automatically flow back and forth between the Resource and approval-manager(s).

Although the system was designed for Professional Services organizations. it could be applied to any business or individual. The system supports multiple contracts for each client and multiple projects for each contract. In addition, there are four major contract types and many ways of calculating billing.

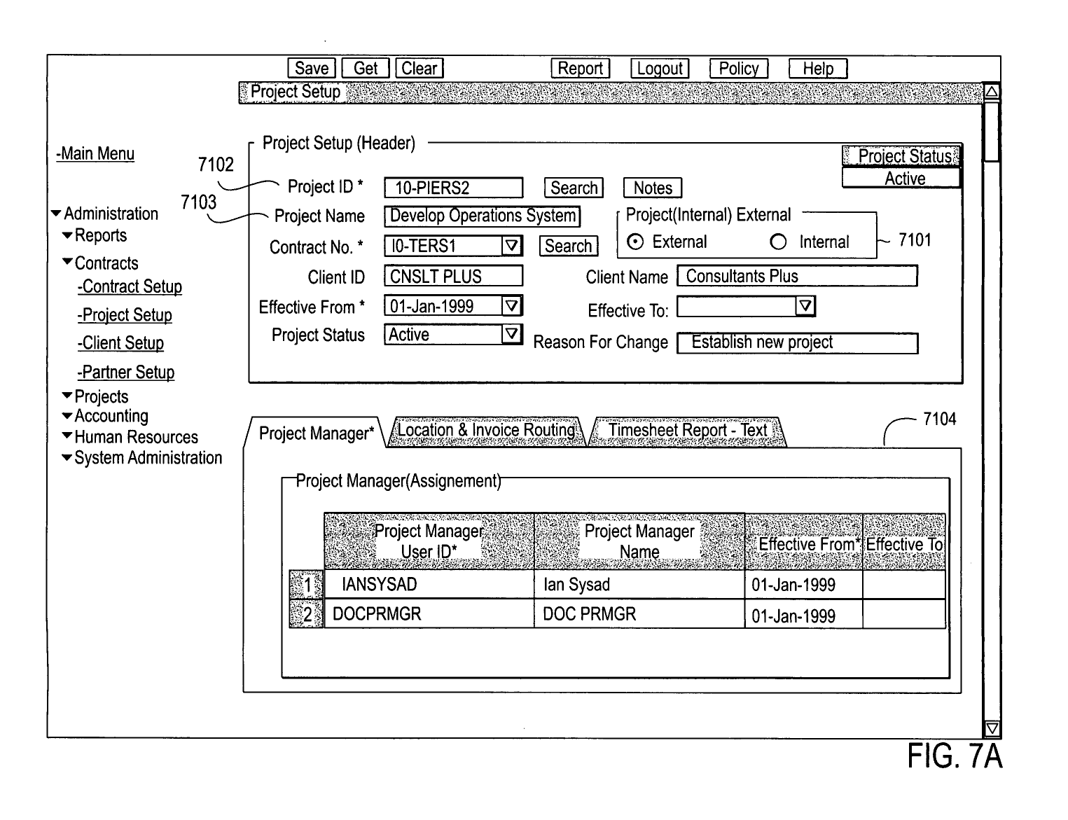

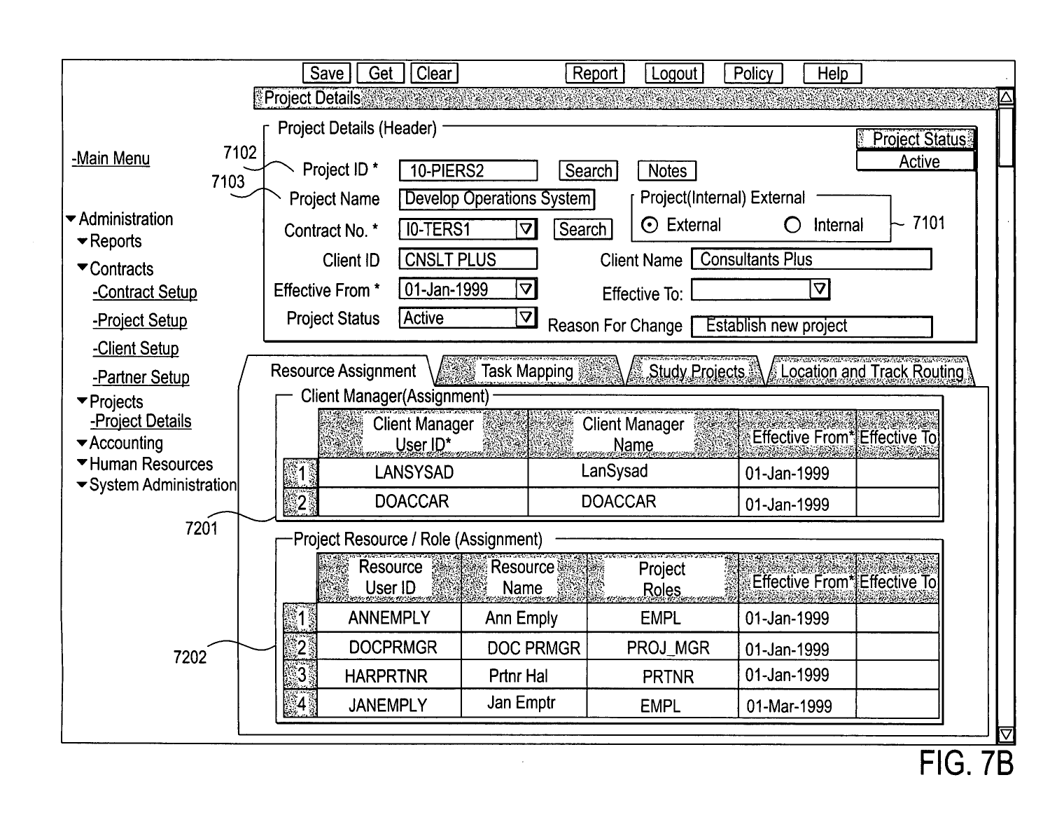

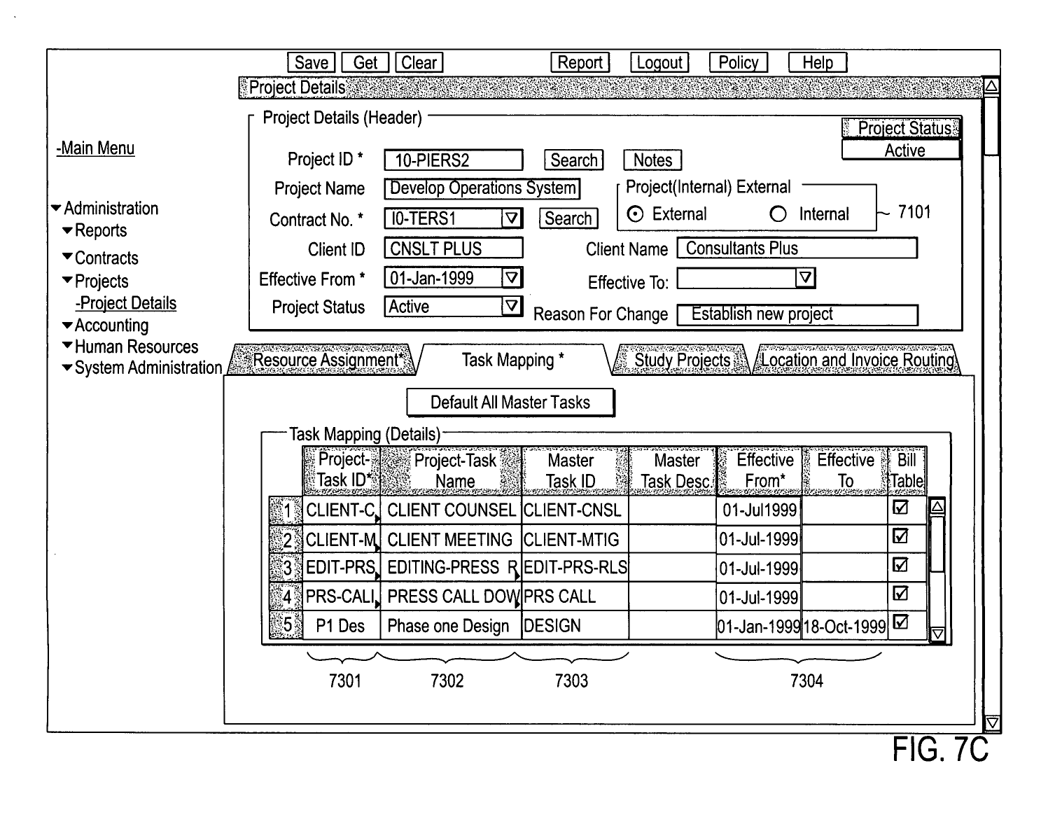

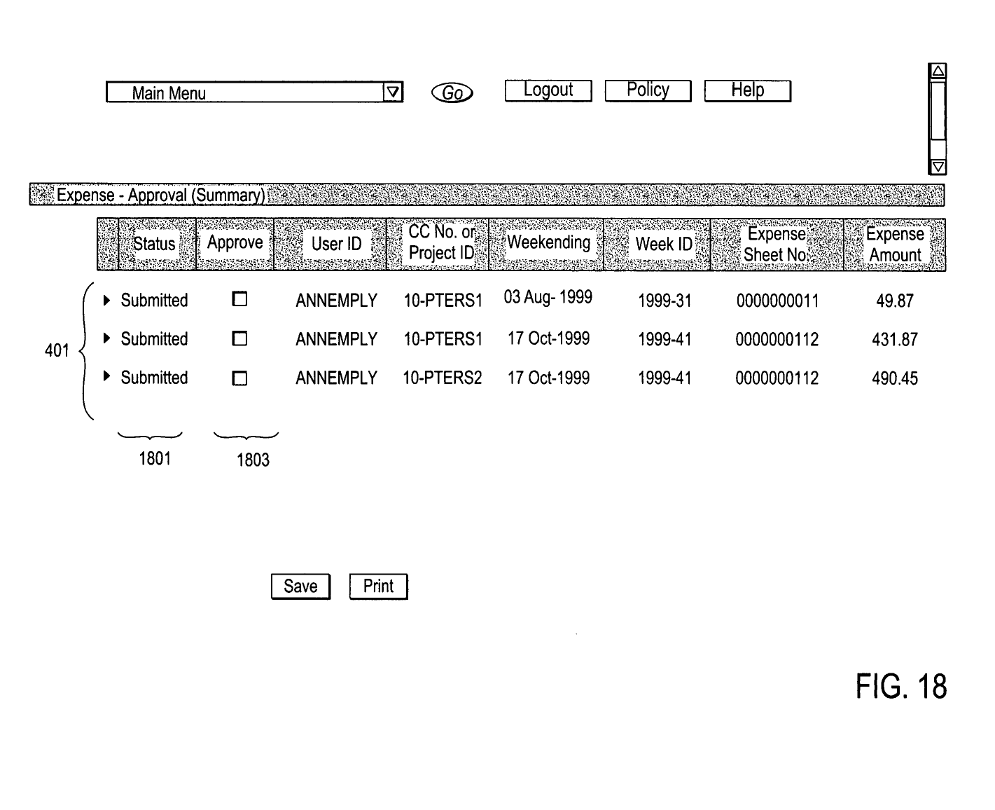

The Contract Screens (FIGS. 6A-6D) and Project screens (FIGS. 7A and 7B) control access to and configuration of the Timesheet (FIG. 2) and Expense Sheet Entry (FIG. 4) and Approval screens (FIG. 18). Parameters in these screens also control the timesheet approval routing amongst the approving project and client managers.

Referring to FIGS. 6A-6D, in one embodiment, the Contract screen parameters contain eleven different factors that control how the timesheet-hours billables are calculated for invoicing to the client. The parameters are a contract number (6106), a client ID (6107), an effective from date (6108), a practice group (6109), contract status (6110), a contract name (6111), a client name (6112), an effective to date (6113), a category (6114), a group (6115) and an estimated contract value (6116). These parameters control, the basis for billing, the rates, billing caps, taxes and even the invoice summation level (6303) such as at client, contract, project or resource level. Practice group (6109), category (6114), and group (6115) support summarization of performance in data reports across multiple contracts based upon their selected values. The Accounts Receivable Assignment (6102) directs routing of billable time and expenses for invoicing by the assigned Accounts Receivable clerk.

The system supports a contract hierarchy for contract management and reporting. Each client may have multiple contracts and each contract can have multiple projects. Each project can have an unlimited number of resources assigned to it.

Referring to FIG. 6B, four Contract Types (6201) cover many professional services. The four types of Contract Types (6201) are: Time and Expense, Fixed Bid, Maintenance and Retainer. All four of these contract types (6201) drive time sheet and expense sheet configuration and drive the time collection, and billing processes. Actual billing controls vary between contract types.

The Time and Expense contract type (6201) is billed by the quantity of timesheet hours multiplied by the hourly rate (6204) per the Bill-by-Rule base (6202) and modified per Rate Type selection (6203). Rate types include Hourly Rate, Hourly Rate Not-to-Exceed, Daily Rate and Monthly Rate. The base can either be by: 1) Resource, 2) Task or 3) Role. The contract setup screen allows for the assignment of the one of the three Bill-by-Rules (6202), and then entry of the monetary amount to be billed per hour for the selected base (6204).

In another embodiment, the Fixed Bid contract type is billed based on an entered milestone or event. Also entered are the event's monetary Value, the Estimated Completion Date and the Actual Completion Date. Timesheet hours are still entered which allow tracking of hours spent and their associated costs. The client is not billed until the Actual Completion Date is entered. At this point, the Value of the billable event is the event Value, plus the Tax Rate Percentage, if entered.

Yet in another embodiment, the Maintenance contract type is billed based on the Period Type and the Bill Amount. (Period Type is either One Time or Recurring. If Recurring then the Bill Frequency is either Monthly or Yearly). Timesheet hours are still entered which allow tracking of hours spent and their associated costs. A Bill Partial Amount is also available so that the last period amount to be billed will bring the entire billable sum to that equal to the contracted amount.

Still, in another embodiment, the Retainer contract type is billed in a similar manner to the Maintenance contract type. The difference is that there may be a number of hours that are not billed per the contract, “Free Hours” and there after the hours are billed per an hourly billing rate. To accommodate these additional parameters, the system supports a Free Hours Type field of Unlimited, Limited or None. If the Free Hours Type is Unlimited or Limited, the system also supports the entry of the hourly rate for the resource to be assigned. In the case of limited, the system also supports the number of Free Hours to which the contract is limited.

Still referring to FIG. 6B, contract types (6201) configure the timesheet entry screen (FIG. 2) and control the valid entries. Though they may differ depending upon the type, some basic controls exist for the contract types (6201). Contracts have three status levels (6110), (1) Planned, (2) Active and (3) Closed. Timesheet data cannot be entered against a particular contract unless the status of the project and the associated contract is “Active.” Without this situation, the project will not be displayed on a resource's timesheet entry screen project dropdown list, and therefore no hours can be entered against the project.

The major controls for contracts, such as resource, task, billing rate and project manager assignments are entered with From (6108) and To Effectivity Dates (6113). This allows the contract/project managers to control the date range within which these data elements are valid and will appear on the dropdown lists in the Timesheet Entry screen (FIG. 2).

Also associated with tasks are billing flags. Each task is marked as Billable or Not-Billable at the company level and can be changed in the contract/project screens. Whenever a project/task is selected on the timesheet, the associated billable flag and its default value (billable or non-billable) is displayed. The resource then has the opportunity to override the task's billable flag, but if it is overridden a large black colored exception indicator is present to call the approving manager's attention to the overridden billable flag. The system does not prevent resources from entering time worked, but the client will not be invoiced unless it is per the contract/project parameters.

Referring to FIG. 6C, the contract/project parameters control the number of approval steps and who will approve the timesheet data. In the Contract Setup screen's Approval Routing (6301) the timesheet can be routed to: 1) the project manager, 2) the client manager or 3) both the project and client manager.

Referring to FIG. 6A, in the contract/project screens are also assigned the project manager (6101), the client manager and the accounts receivable clerk (6102). Only the assigned User IDs will see the timesheet data for approval/processing. More than one manager/clerk can be assigned in parallel where appropriate, and if any one of the two parallel manager approves/processes the time, the time moves on to the next status level. In other words, both parallel assigned managers will not take action on the same hours to be approved/processed. In another embodiment, the system supports approval routing where action by parallel assigned managers is required.

Contract types (6201) configure the expense sheet entry screen and control the valid billable entries. As in timesheet entries above expense sheet data cannot be entered against a particular project unless the status of the project is “Active.” Also, as in timesheet entries above expenses cannot be entered by a resource unless he/she was assigned to the target project during the time the expense occurred.

As in timesheet entries above whether or not a particular expense is Billable depends on the type of contract and billable flag. When an expense is entered into a billable project and the expense flag value is changed to Non-billable, a large black colored exception indicator is present to call the approving manager's attention to the overridden billable flag. The system does not prevent resources from entering expenses spent, but the client will not be invoiced unless it is per the contract/project parameters.

Accounting is not alerted that action is required until the billables and expenses are ready for processing. Before the billables and expenses arrive for accounting review and processing, the Resource keyed them into the system, the system validated all entries during the entry processes, and they were approved by the appropriate managers.

Upon completion of the approval process, the system calculates the billable (and its associated costs) with all of the contract/project contractual limitations included. Then and only then is the billable ready for accounting to sum into Invoices, and even the calculations for the summation are done by the system.

Referring to FIG. 6B, the contract types (6201), Time and Expense (Bill-By Resource, Role, Task (6202)), Fixed Bid, Maintenance and Retainer, effect how the billables are calculated as does the Rate Type selection (6203). Depending on the contract type and the values of the parameters selected. there are many different factors involved. In one embodiment, the timesheet hours are multiplied by the applicable rate and then modified by any maximum or minimum amount of taxation percentage. Fixed Bid, and the Non-Free Hours associated with Maintenance and Retainer Contracts are handled as flat-fees, but taxation may still be added. Below is an explanation of the eleven significant factors/methods of calculating the timesheet billables.

1) Bill by Resource (Time and Expense Type)—Referring to FIG. 6B. the Resource (6218) and his/her hourly rate (6204) is assigned at the contract level. The Resource is then assigned to one or more projects, but in all projects for this contract. the billing rate per hour is the same. The Resource's timesheet hours are multiplied by this rate and may be altered due to the other factors.

2) Bill by Task (Time and Expense Type)—The Task and a task hourly rate is assigned at the contract level. The task is then assigned to one or more projects, but in all projects for this contract, the billing rate per hour is the same. The Resource's timesheet hours are entered against the project/task and these hours are multiplied by the contract's task rate. The resulting product may be altered due to other factors.

3) Bill by Role (Time and Expense Type)—A Company Role and a project-role hourly rate are assigned at the contract level. A resources are then assigned to the projects and each project assignment includes a project-role assignment. For all projects for this contract, the billing rate per hour for a project-role is the same. A Resource's timesheet hours are entered and are multiplied by a resource's linked project-role rate. The resulting product may be altered due to the other factors.

4) Daily (Min. Max. Hours/Day)—The contract may include a minimum and maximum number of hours per day. If a number of timesheet hours entered for the contract (across the associated projects) in a day is less the minimum number of hours, no hours will be billed. If a number of timesheet hours entered for the contract (across the associated projects) in a day is greater than the maximum number of hours, only the maximum number of hours will be billed. This billing method is selected via the Bill-Rate Type (6203).

5) Hourly—This is the simplest factor. The timesheet hours entered are simply multiplied by the applicable hourly rate. This billing method is selected via the Bill-Rate Type (6203).

6) Hourly Not-To-Exceed (Maximum Hours/Day)—This is the same as the Daily method above, with the exception that there is no minimum number of hours per day. If the number of timesheet hours entered for the contract (across the associated projects) in a day is greater than the maximum number of hours, only the maximum number of hours will be billed. This billing method is selected via the Bill-Rate Type (6203).

7) Monthly Standard Hours Per Month)—When the contract is billed as Monthly, the resource will continue to enter timesheet hours, but these hours will not be used in calculating the billable for the month. The timesheet hours will be used to track time spent and company costs. The time related billable is calculated as the resource's project hourly rate multiplied by the contract's Standard Hours Per Month value. In cases where this calculated billable is inappropriate, such as the resource having a significant amount of Off-time hours (vacation, sick, etc.) in a month, the system allows an accounts receivable clerk to make an Adjustment to offset a portion or the entire billable amount. This billing method is selected via the Bill-Rate Type (6203).

8) Fixed Bid—When the Contract Type is a Fixed Bid, the billable is a predefined amount “Value” associated with an event or milestone. When the Event is marked as completed, a billable for the Event Value will be generated. The resource will continue to enter timesheet hours, but these hours will not be used in calculating the billable. The timesheet hours will be used to track time spent and company costs.

9) Maintenance—When the Contract Type is Maintenance, there is either a One Time or Recurring (Monthly or Yearly) payment. The actual number of hours spent will all be treated as “Free Hours” as no further charge will be made. Also entered into the Contract Setup screen is the Bill Amount/Period and any Last Partial Amount. The system will process the Bill Amount as a Billable one time or each month or year. In the case of a Last Partial Amount, this is the amount that will be billed in the last period of the contract the last period amount to be billed will bring the entire contract's billable sum to that equal to the actual contracted amount.

10) Retainer—Retainer and Maintenance billable calculations are similar. however, Retainer may also have “Free Hours” set as “Limited” or “None.” In this case, the system will require entry of the amount of Free Hours, if any, and the Hourly Rate at which these hours are to be billed. The system will keep track of the total number of timesheet hours entered and begin billing after all “Free Hours” have been consumed.

11) Taxation (Professional Time Service Tax)—In those countries that have a service tax applied to professional time, this feature allows the tax to be collected for later payment to the government. This tax may be applied to the results of any of the above calculation methods, thus increasing the billable amount by the entered taxation percentage. FIG. 6C shows that the Professional Time (Taxation Type) (6305) is selected on the Contract Setup Screen.

The system generates all Invoices per contractual parameters. Accounting selects the pre-calculated billables using system filters and can exclude particular billables from inclusion in the invoices to be generated, but the actual summation of invoices is done by the system. The system ensures that the separation of many billables for the various clients, contracts, projects and invoices is done per the contract parameters. The system also does all of the calculations for the summation of the billables contained in an invoice.

Referring to FIG. 6C, one of the parameters setup in the system is the “Invoice At Level” (6303). This setting determines how billables will be summarized into individual invoices. Invoices may summarize all the billables at the level of: Client. Contract, Project, Resource or Project/Resource. The Client-level value for the Invoice At Level (6303) is set in a Client Setup screen, while any one of the other values can be set in a Contract Setup screen (FIGS. 6A-6D).

Summarization of an invoice at the higher levels, contains the resource identification, the work week, the number of hours spent, the rate and the resulting billable. Invoices formats are user definable thus any reasonable detail omission can be selected.

The system also supports entry of Bill-To Attention information for use in Invoice Formats. Referring to FIG. 6E, the system stores billing address information (6501). Invoice Payment Terms (6502) and User Defined Fields (6503). It also has a place for a Route-To Address for those situations where the Invoice is to be routed to a client manager for approval prior to its being sent to the client's accounting department for payment.

Referring to FIG. 6F, the system allows three different overtime percentage rates (6601) used to calculate an increased hourly rate charged for overtime hours. These percentage rates are Effective To and From Date (6602) controlled.

The contractual revenue limitations are automatically included in billable calculations and invoice generation. Referring to FIG. 6D, the contract/project parameters (6401) contain four different Expense Rules (6401): Fixed, Reasonable, Not-To-Exceed/Person/Day and None.

Resources are allowed to enter expenses actually spent, no matter what the contractual expense rule, but the system will only invoice up to the maximum allowed per the contractual parameters. It is up to the project manager to ensure that, a) the resource should be reimbursed and b) to recognize that, per the contractual parameters a particular contract's “Billables” may not be billed.

When the Expense Rule (6401) is “Fixed”, the billable is a predefined expense amount “Value” associated with an expense event or milestone. When the expense Event is marked as completed, a billable for the expense Event Value will be generated. The resource may continue to enter expenses, but these expenses will not be used in calculating the client billable. These expense entries will be used to track expenses spent and may be used to reimburse the resource.

When the Expense Rule (6401) is “Reasonable”, the billables will be the same as the amounts entered into the Expense Sheet screen (FIG. 4) and marked as Billable. This is the most commonly used expense rule and only requires some review on the part of the project manager and good communication with the client to ensure invoices are paid promptly.

When the Expense Rule (6401) is “Not-To-Exceed” (NTE), the billables will equal the lesser of the amounts entered into the Expense Sheet screen (FIG. 4) and marked as Billable, or a NTE amount. The resource may continue to enter expenses greater than the contractual NTE amount. These expense entries will be used to track actual expense costs and also may be used to reimburse the resource.

When the Expense Rule (6401) is “None”, the billables will be zero. The resource may continue to enter expenses against the contract/project. These expense entries will be used to track actual expense costs and also may be used to reimburse the resource.

Referring to FIG. 7A, the system supports two types of projects (7101). The first is the client-contract related External Project that is billable to a client. The second is an Internal Project that is not associated with a client-contract and thus, is not billable. The system automatically routes Billables for External Projects to the client via the Timesheet Approval and Invoice Generation processes. Of course the system will not allow entry of Billable hours against an Internal Project (non-billable project). The Project Manager Assignment (7104) is used to assign the project manager who must approve the time and expense sheets sent by the Resources.

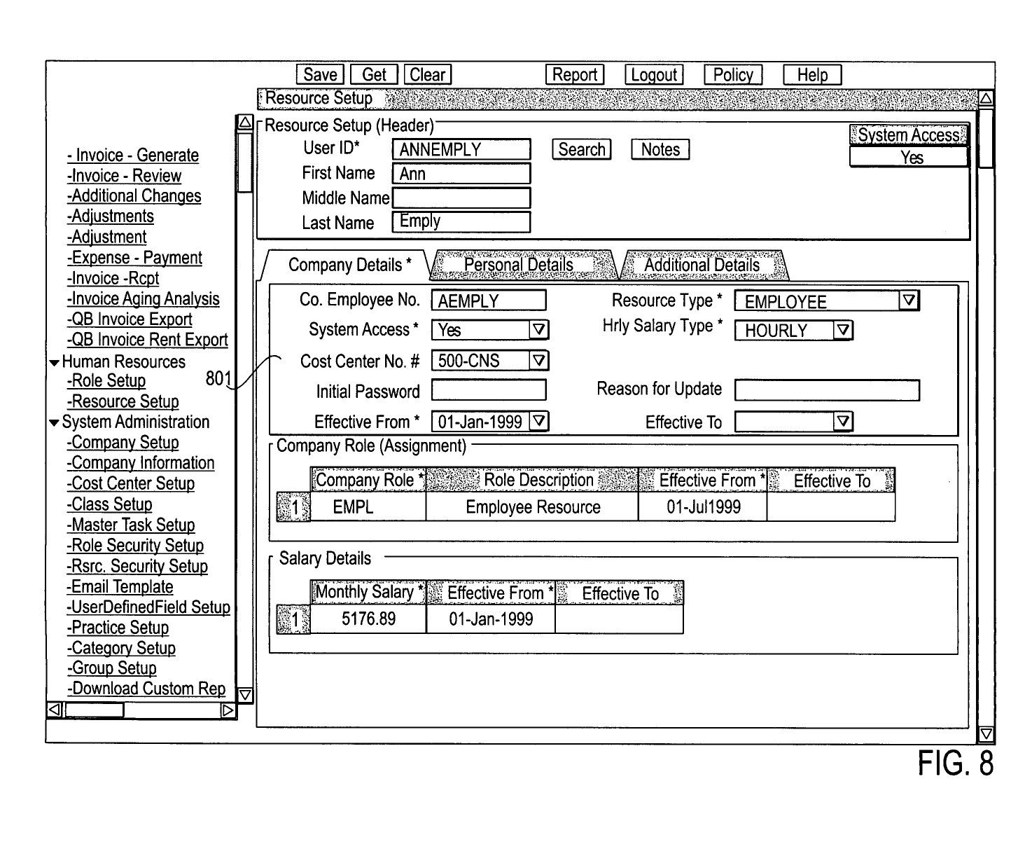

Cost data is routed to either the External Project or to the Cost Center linked to the Internal Project. Non-project related time, Off-time such as Holiday and Sick time. is routed to the Cost Center that is linked to the Resource entering the time. This Cost Center/Resource link is made in the Resource Setup screen (FIG. 8).

Referring to FIG. 7B, the client manager assignment (7201) is used to assign the client manager who must approve the time and expense sheets sent by the Resources. The contract/project assignment of Resources (7202) controls the resources ability to charge time to the contract/project. In the Timesheet Entry screen (FIG. 2), all projects to be charged are identified by selecting the project from the project dropdown list (220). Unless the resource is assigned to the contact/project during the particular workweek (7202), the project will not be a part of that project dropdown list.

Each resource associated with a contract/project type, other than Fixed Bid or Maintenance is directly or indirectly assigned with an hourly rate. In the case of a Time and Expense (Bill-By-Resource) contract or Retainer Contract, the hourly rate is directly assigned to a particular resource. In the case of a Time and Expense (Bill-By-Role or Task) contract, the hourly rate is assigned to the role or the task and the resource is linked to the Role in the Project Details screen, or selects the task in the Timesheet Entry screen.

The contract/project assignment of tasks controls the resource's ability to charge time to the particular task for the contract/project. In the Timesheet Entry screen (FIG. 2), all tasks to be charged are identified by selecting the task from the task dropdown list. Unless the task is assigned to the contract/project during the particular workweek. the task will not be a part of that project's task dropdown list (220).

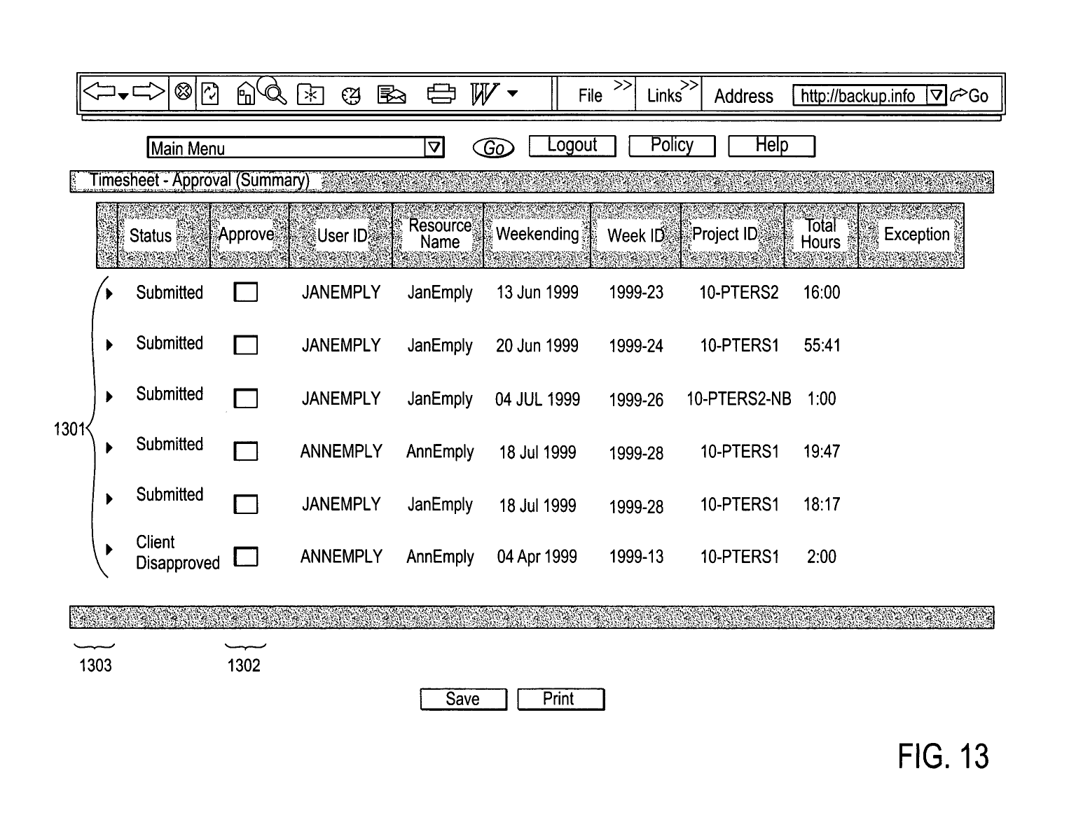

Referring to FIG. 7C, each project task can have a Project-Task ID (7301) and Project-Task Name (7302). This allows the project manager to have the project-plan's specific Project-Task IDs (7301) appear on the Timesheet Entry screen dropdown list (220) and timesheet approval screens (FIG. 13) and reports. Each project-task may be linked to one of the company's Master Tasks allowing standardization of Master Task IDs (7303) to support summarization and analysis of all hours entered against tasks.

### Time Handling

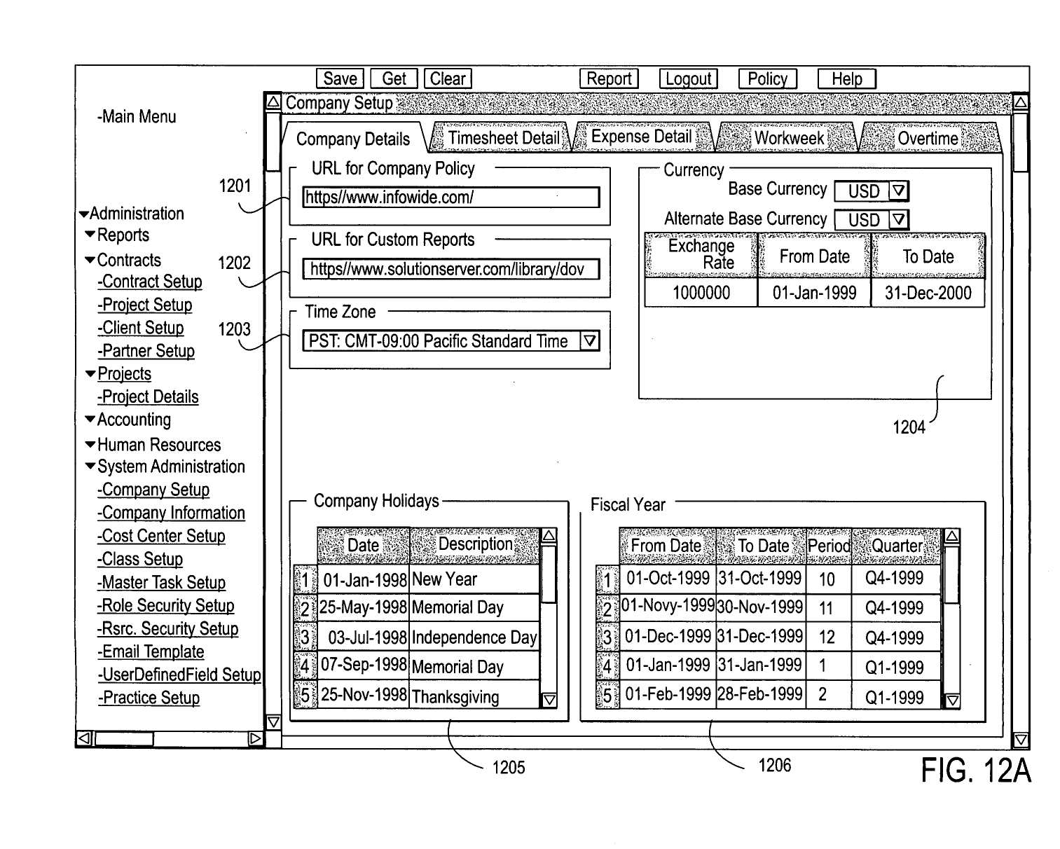

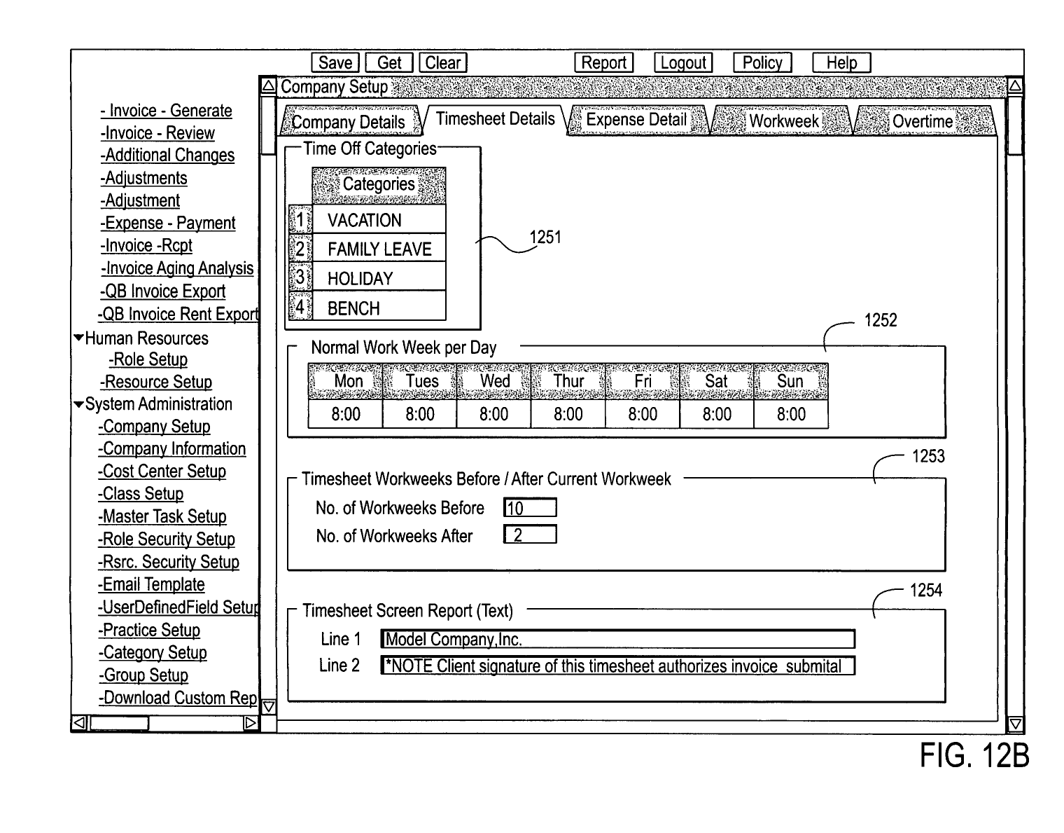

The timesheet data flows through the approval process based on a six-step status system described below and also the parameters and assignments previously entered into the company (FIGS. 12A and 12B) and contract setup screens (FIGS. 6A-6D). The system routes the timesheet data in a fine-grained method. The timesheet is divided into individual row/column time-cells and these are routed through the approval process. Each cell has it's own approval status making it possible to approve and invoice most time while routing back the disapproved time.

Referring to FIG. 13, the approval process can be done at the Resource/Project Level, or time can be approved/disapproved at the individual project/task/day level. All approval/disapproval processing is done on an exception basis so that the manager only needs to look at those specific times for which action is required.

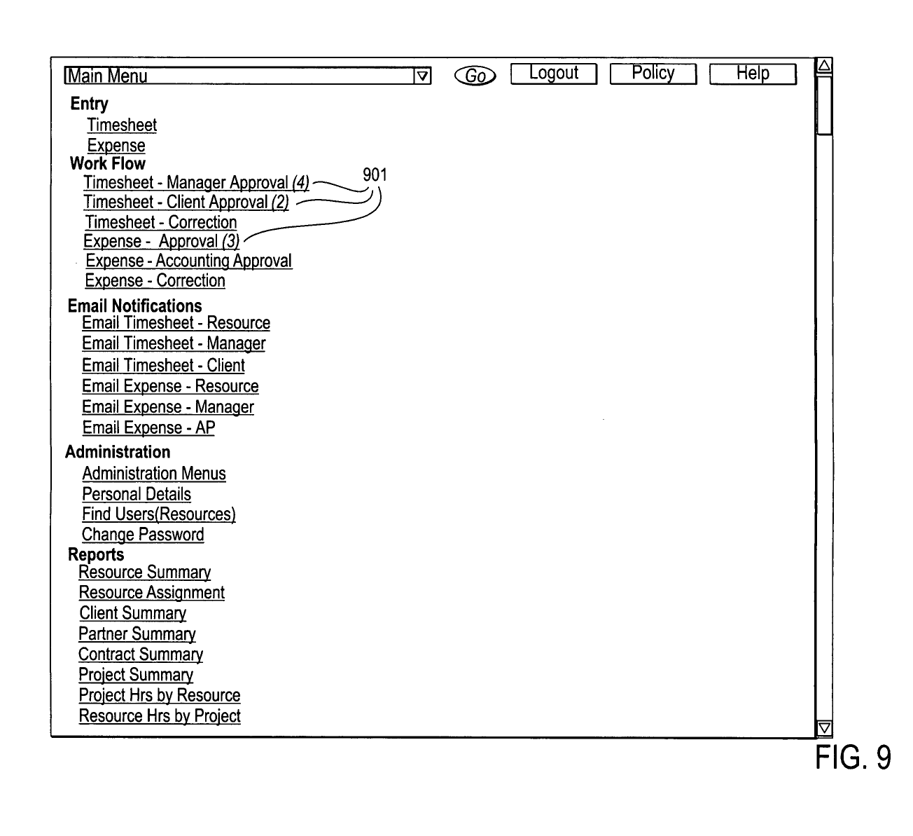

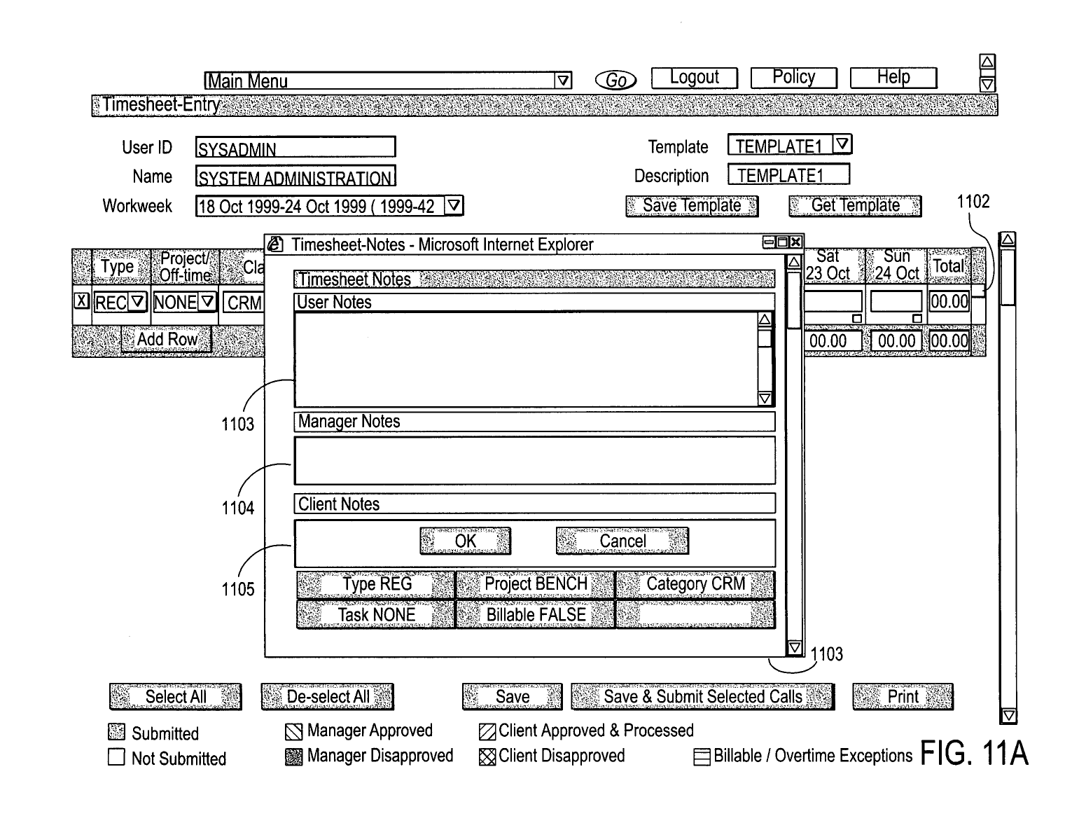

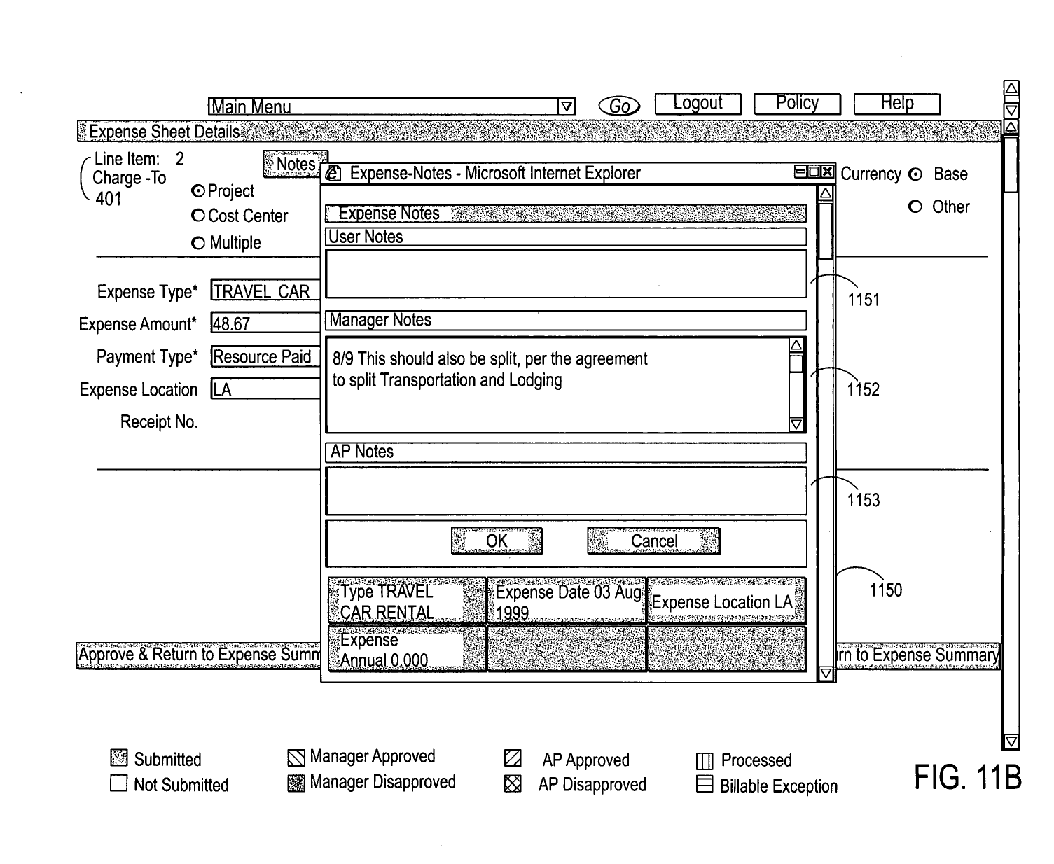

Additional tools are also provided to help with other aspects of timesheet management. Referring to FIG. 9, Workflow numbers (901) are provided on the system's main menu, just to the right of the screen that needs to be used. Thus, the resource or manager can quickly see the volume and types of actions required. Referring to FIG. 11, notes (1101) are provided for each timesheet-row (1102) and include inputs from the resource (1103), the approving manager (1104) and the client manager (1105).

Referring to FIG. 11A, when time-cells are disapproved, the manager adds an explanatory note (1104) to the resource explaining what the problem is and what action should be taken. Manager Approved time-cells flow on to the next step in the approval process and disapproved time-cells flow back to the resource's Timesheet-Correction screen.

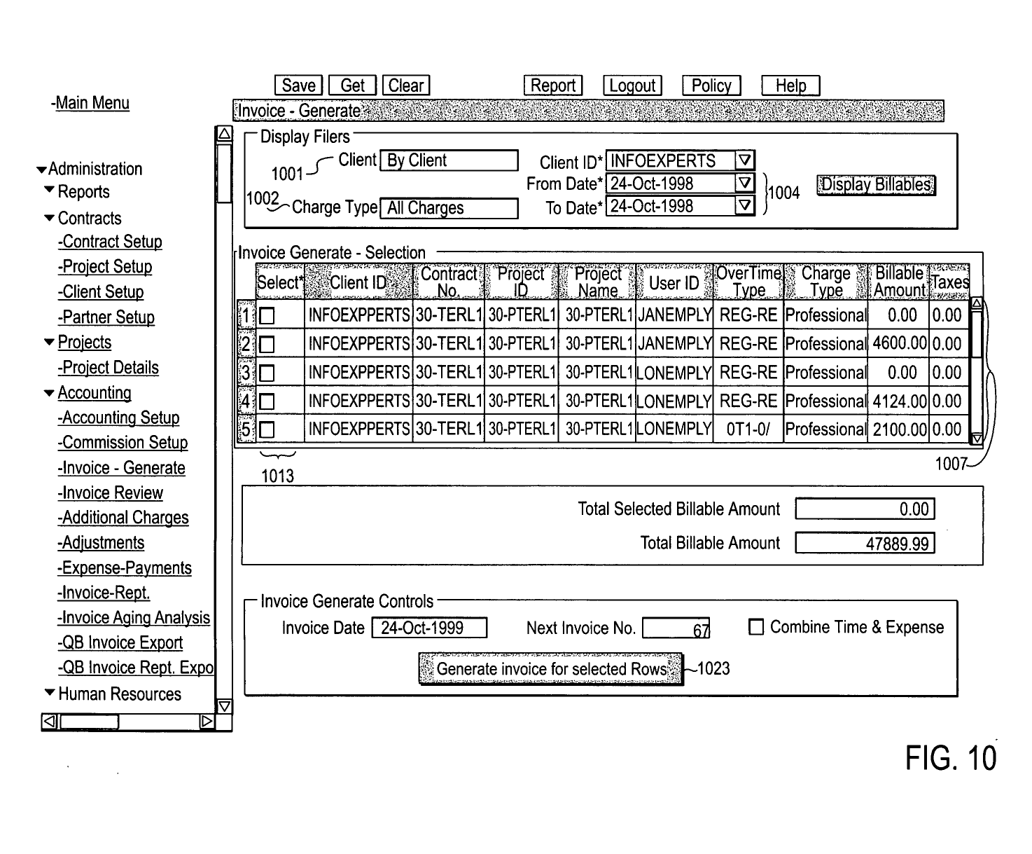

When time-cells are disapproved by the client manager, the client manager adds an explanatory note (1105) to the project manager explaining what the problem is and what action should be taken. Client Manager Approved time-cells flow on to the final step in the approval process and are displayed in the Invoice Generation screen (FIG. 10).

Internet access through HTML screens is used for fast response time, and all entries. with the exception of the hours and optional notes, are point and click from pre-configured dropdown lists that contain only the valid entries possible for that resource project. task and date.

Referring back to FIG. 2, four personal timesheet-templates are available for each resource making it possible to enter a complex week's time with dozens of data elements. When a timesheet has been filled out, the Save Template button (281) is selected to store the timesheet. In following weeks, the template can be retrieved by clicking the Get Template Button (282). At this point there may be minor changes in hours, but otherwise the entire timesheet is ready for submittal. When the resource submits the timesheet for approval, the system automatically separates the timesheet by type of time and project and routes the time to the appropriate manager(s) per the company and contract parameters.

Referring to FIG. 2 there are two Types of Time: Regular (211) and Off-time (212). Associated with the Regular time are also the Overtime (OT) (213) rates 1 through 3. Regular time (211) and OT (213) is for hours to be charged against projects. Off-time (212) hours are those hours not associated with a project, such as holiday, vacation and sick hours. These two time types determine what data elements define a timesheet row and whether or not the time is approved by a project and/or client manager, for Regular (211) and OT (213) time, or just by a cost center manager for Off-time.

Regular and OT timesheet rows are defined by five different data elements: Time-type (210), Project (220), Class (230), Task (240) and Bill-flag (250). A change in any one of these five data elements requires a new row in the timesheet. These five data elements in the row, plus the weekday (260) in the column identify a particular time-cell in the workweek timesheet.

Off-time timesheet rows are defined by three different data elements: Time-type (210), Off-time (212), Category (220) and Class (230). A change in any one of these three data elements requires a new row in the timesheet. These three data elements in the row, plus the weekday in the column identify a particular time-cell in the workweek timesheet.

How the system routes the timesheet time-cells through the approval process depends on the Type of Time (210): Regular (211), OT (213) or Off-time (212). Approval routing for Regular (211) and OT (213) time is based on two factors. First. the required approval routing is set in a Contract Setup screen (FIG. 6C), Processing Rules Tab (6304) as: project manager, client manager or both (6301). Then, in the Project Details screen, (FIG. 7B) the specific project and client managers are assigned (7201). Regular (211) and OT (213) time is routed through the project manager, client manager or both (depending on the Contract Setup screens selected Approval Routing setting (6301)). Upon completion of the approval process it is routed to accounting for invoice processing.

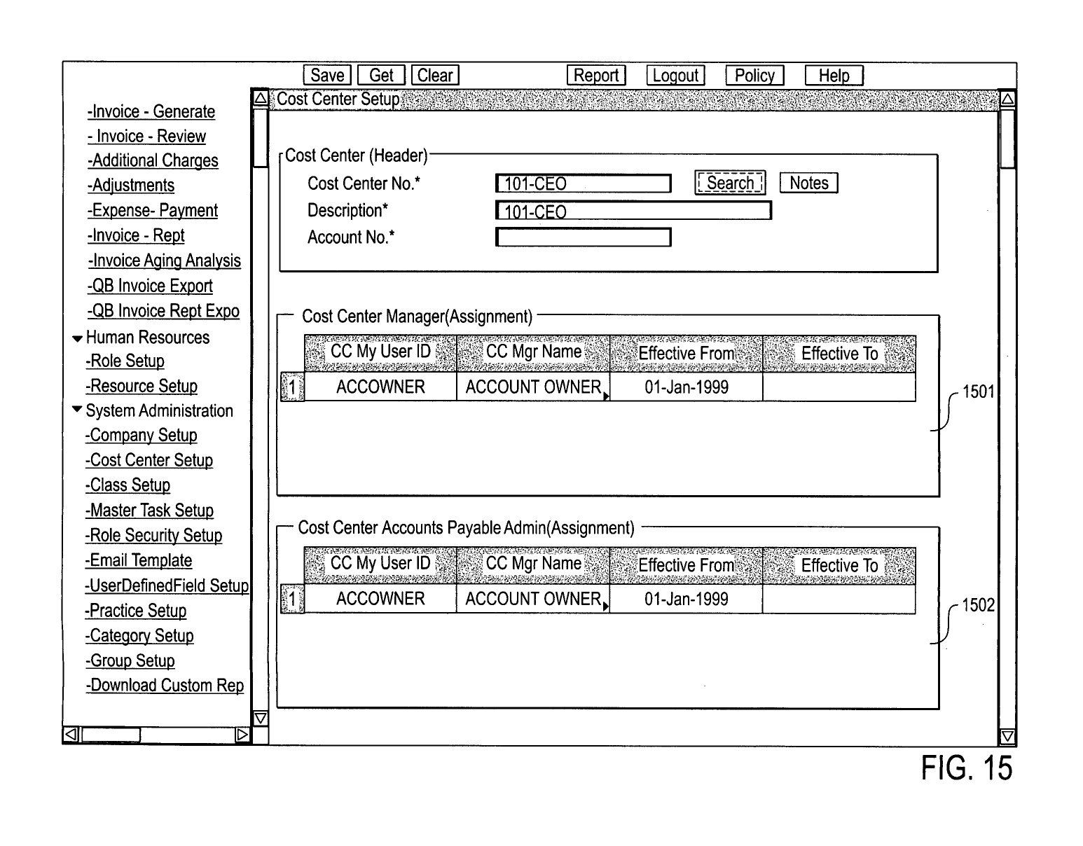

Approval routing for Off-time (214) time-cells is based on two assignments. The first assignment is the cost center assignment (801) made for the timesheet owner in the Resource Setup screen (FIG. 8). Second is which user was assigned as the cost center manager for the resource's assigned cost center (1501) in the Cost Center Setup screen (FIG. 15). Off-time (214) is always routed through the cost center manager and, when approved, to accounting.

Main menu workflow flags (901) indicate to the employee when corrections are needed, due to late-unsubmitted time or manager disapproval. A timesheet correction screen shows a time-cell status-color indicating which hours need to be corrected, and a timesheet's row notes display the disapproving manager's explanatory comments.

Each individual resource's timesheet is pre-configured based on the company setup and contract setup parameters. Only valid entries are available to choose from on the dropdown entry lists, per company and contract requirements.

These pre-entered parameters also control post timesheet entry processing. Timesheet data is routed for approval based on company and contract parameters. Also. cost and revenue calculations automatically include the rate per time period and any maximum, minimum and not-to-exceed amounts.

Referring to FIG. 12A, Company Setup establishes Company Policy URLs (1201), custom report URLs (1202), the company's Time Zone (1203), currency (1204), company Holidays (1205) and the company's Fiscal Year (1206). Referring to FIG. 12B, Company Setup also establishes time-off categories (1251), the normal work hours (1252), workweek (1253) and Screen report (1254). Timesheet configuring parameters are established in Contract Setup Screen (FIGS. 6A-6D). These include, the beginning and ending date for the basic workweek, valid entries for off-time categories, such as Holiday and Sick, and classes that are the basic types of work being done. These entries are Effective From (6108) and To Date (6113) controlled.

In addition the system has a complete cost center system to aid tracking of non-project related costs and activities. Referring to FIG. 15, Cost Centers are established and cost center managers (1501) are assigned. Off-time timesheet hours are routed to these managers for approval.

Just as the company setup helps set the basic parameters for collection of timesheet data, contract and project setup adds additional controls to the timesheet process. Through the contract and project setup the system ensures all project-related timesheet entries conform to the client's contractual requirements, and all billable time calculations include the contract's hourly rates and any not-to-exceed amounts. All project-related time is routed for approval based on the contract's routing parameters, and all of the above controls are effectivity dated to add the flexibility needed.

As described above, all billable amounts and controls are entered into the Contract Setup screen Bill-Rate Type (6203), including hourly, daily and monthly rates, minimum. maximum and not-to-exceed amounts, and whether the approval process (6301) includes the project manager, the client manager or both. Also entered into the Contract Setup or Project Setup screen is the valid list of assigned Resources, and the valid tasks, depending on the Contract Type. All of these parameters are Effective From (6108) and To Date (6113) controlled. Thus, timesheet entries are valid per the client's contractual requirements as invalid entries are not available on the timesheet dropdown lists.

When a resource submits a timesheet for approval, the system automatically routes the timesheet's off-time hours to the appropriate cost center manager for approval. All of the timesheet's contract and project related regular time is routed to the appropriate project and/or client manager for approval per a selected approved routing (6301) in the Contract Setup screen (FIG. 6C).

The system separates the timesheet and routes the timesheet hours through the approval process per the company and contract setup parameters. and also tracks the routing per a six-step status system described above. Thus, all time is routed per its status and also to the appropriate approving manager(s).

All timesheet hours are routed for approval through a six-step status system. In order they are: 1) Saved, 2) Submitted, 3) Manager Disapproved, 4) Manager Approved, 5) Client Disapproved, 6) Client Approved/Processed. Depending on the Type of Time (Regular or Off-time) and the contractual requirements, not all time is approved through the two approval steps. In addition, the two Disapproved status levels are only used when a manager indicates it is needed.

Referring to FIG. 2, to aid quick identification of a time-cells status, the timesheet contains a color status bar (261). Each time-cell's color status bar will contain the color associated with that cell's particular status. This way it is very easy to see which cells require action. In addition, only those cells that require action will still contain a check box (262).

1) Saved Status—The saved status indicates the time has been entered and saved to the database. but the resource has not submitted it for approval. This time is not visible in the manager's approval screens. Saved time for prior workweeks will be displayed in the main menu workflow numbers of a Timesheet-Correction screen. This helps ensure that possible revenue hours are not forgotten. The resource can modify these time-cells.

2) Submitted Status—The submitted status indicates that the resource has entered and reviewed the timesheet data and submitted it for approval. This time flows to the appropriate manager's approval screen (project manager, client manager or cost center manager) depending on the Time Type (210) and the Contract Setup screen's Approval Routing setting (6301). These time-cells can be modified by the resource, or the approval manager can change the status.

3) Manager Disapproved Status—The manager disapproved status indicates the time-cell(s) were submitted by the resource and then, or after a client manager disapproval, were disapproved by the manager. This time flows back to the resource's Timesheet-Correction screen for correction. The resource and no one else can modify these time-cells.

4) Manager Approved Status—The manager approved status indicates the time-cell(s) were submitted by the resource and then, or after a client manager disapproval, were approved by the manager. This time flows forward to the client manager's approval screen for approval or to the Client Approved/Processed status, depending on the Time Type (210) and the Contract Setup screen's Approval Routing setting (6301). The client manager can change the status of these time-cells.

5) Client Manager Disapproved Status—The client manager disapproved status indicates the time-cell(s) were approved by the manager and then, were disapproved by the client manager. This time flows back to a contract or project manager's approval screen.

6) Client Approved/Processed—The client manager approved status indicates the time-cell(s) were approved by the manager. if required per contract. and then approved by the client manager. A client manager does not approve time-off hours. This time is now available for invoice processing and cannot be changed. If changes in hours and/or dollars are warranted, accounting can do an accounting adjustment through an Adjustment screen.

To prevent delay of the majority of billable hours because a small amount of the timesheet hours were disapproved, the system handles each timesheet row/column “time-cell” as a separate document in the approval process. Each time-cell has its own status and is routed through the approval process accordingly. It is this fine-grained management of the timesheet data approval process that is unique to this timesheet product.

Referring to FIG. 13, as described above, the manager's Timesheet-Approval screen displays those time-sheet rows (1301) that he/she is assigned to review and approve or disapprove. In the case of Off-time (214), this is the cost center manager for the cost center linked to the resource in the Resource Setup screen (FIG. 8). In the case of Regular (211) and OT (213), project hours, it is the project manager (7104) assigned in the Project Setup screen (FIG. 7A).

Referring to FIG. 13, the project/cost center and client manager can approve a resource's entire timesheet-row's worth of time-cells by simply checking the row's checkbox (1302) in the Approval screen's summary grid. The manager has the option of drilling down and seeing the details of the resource's full timesheet by clicking the drill down arrows (1303) and then approving or disapproving at the time-cell level.

As described above, the client manager's Timesheet-Approval screen (FIG. 13) displays those time-sheet rows that he/she is assigned to review and approve or disapprove. A client manager approves only Regular and OT time-cells associated with client contract/projects. The client manager is assigned (7104) in the Project Setup screen (FIG. 7A). Timesheet time-cell data only appears on the client manager's approval screen, as it becomes ready for review. Similarly, time is disapproved in a timesheet on a cell-by-cell basis.

When the billables reach accounting they have already been keyed into the system. validated, and reviewed/approved by the appropriate managers. In addition, the system has already taken into account client parameters such as a contractual Not-To-Exceed amount.

The accounting Invoice Generation screen (FIG. 10) provides filters to help select the outstanding billables to be invoiced: Client (all or specific) (1001). Charge Type (all, professional time, expenses, additional charges) (1002), and From and To Dates (1004). Using these filters the user can generate a list of the billables (1007) to be combined into Invoices. A manual override is available in the form of a checkbox (1013) for each billable. When the Generate Invoice button (1023) is selected, the system separates the billables by client and then combines the individual billables into invoices depending on the Invoice At Level (6303) as set in either the Client Setup screen or the Contract Setup screen (FIG. 6C). By using an integration tool linking the company's financial systems, the resulting invoices can be established.

Accounting generates invoices for all billable hours. Accounting only sees those billables that have been validated and completed the approval cycle as dictated by the company and contract setup parameters.

As shown in FIG. 9, Resources see workflow numbers (901) to the right of the Timesheet-Correction screen on the main menu. Types of corrections include, hours entered, but not submitted, in weeks prior to the current week, and also when the project or cost center manager has disapproved hours submitted by the resource.

Project and cost center managers see workflow numbers to the right of a Timesheet-Approval screen on the main menu. Usually this number indicates hours submitted by resources and awaiting management approval. For project managers, the workflow numbers may also include hours disapproved by the client manager. These workflow numbers are displayed on the main menu and are not displayed in the dropdown menu.

As seen in FIG. 2, for regular/project related hours, each timesheet row already includes identification of a task (240), while in off-time hours, the category of off-time (220), such as holiday or sick is indicated. The resource still has the opportunity to further identify how hours were spent or problems/observations by using the Notes button (290) to the right of the particular timesheet row.

The resource, the manager or the client can enter notes. These notes are kept separate and access to addition or modification of the particular user's notes is controlled by security. Any one of the three can see all three sets of notes associated with the Timesheet row being addressed.

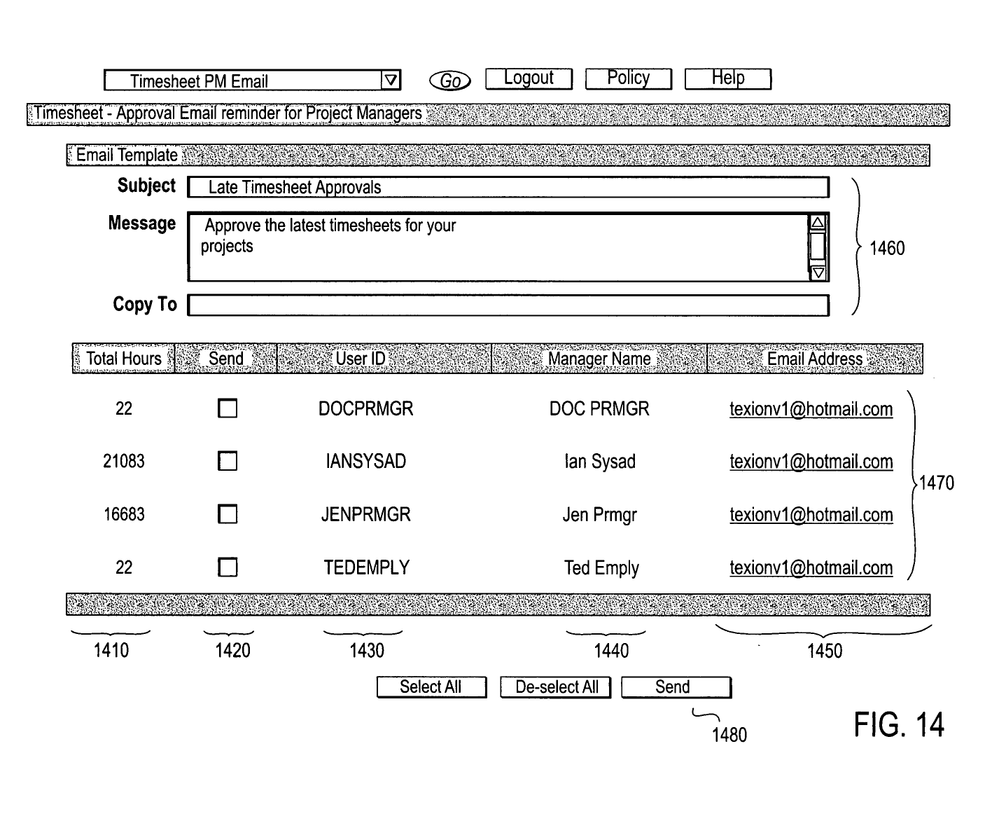

To address the common problem of ensuring all resources have entered their weekly timesheet, the system includes reports to identify late or inadequate timesheet submissions or outstanding timesheet approvals. Referring to FIG. 14, the system contains a semi-automated identification and email notification system so that emails can be efficiently sent to all resources lacking timesheet submissions or managers who are needed to approve time.

Whether report generation or email notification is used a parameter window is provided to help further identify the desired resources. For inadequate timesheet submittal, resources are identified through entry into a filtering parameter window. The selection parameters include: 1) Workweek ID, 2) Project, Cost Center or Both. 3) Specific Project or Cost Center, 4) Hours Less Than. and 5) Resource Type.

The Hours Less Than parameter allows the requester to decide what is the minimum number of hours that must be submitted to be considered an adequate timesheet entry for the week. This assumes that off-time hours are also entered.

For identifying managers and client managers who need to approve time. the managers are identified through entry into a filtering parameter window. The selection parameters include: 1) From Date, 2) To Date, and 3) All or a Specific Manager or Client Manager.

If the parameter window is used to identify inadequate timesheet submissions to receive email notification as in FIG. 14, an additional selection process is available. The system displays the list of resources (1470) meeting the parameter window criteria and also displays a checkbox (1420) to the left of each resource's (1440) row. The checkbox (1420) can be used to remove more resources from the email-target list.

The email notification list window also contains the template (1460) of the text to be contained in the email's subject line and the body of the email. This text is entered through the administrative menu's Email Template screen. This template text can be edited for the particular emailing.

When the Send button (1480) is selected, the system generates a separate email to each of the selected resources, per the email address entered into their respective Resource Setup screen entries (FIG. 8). If a Carbon Copy user email address was entered, the system will also send a copy of each of the resulting emails to that addressee. The requester will also receive an email containing a summary list of the resources notified. A copy of this summary list may then be forwarded to an addressee as opposed to placing their email address in the carbon copy field and inundating them with all of the separate carbon copy emails.

### Expense Handling

As described above, referring to FIG. 4, the Expense Sheet data entry supports Split-Charges (499), Foreign Currency calculations (440), VAT data keeping (435) and Pre-paid Expense Types. This allows the professional resource to enter all of his/her expenses into a single Expense Sheet, even if there are multiple organizations/clients (499) to which the expenses will be charged. The system automatically routes the expense sheet for approval to the appropriate managers per the parameters setup for the company cost centers and the various contracts.

The Expense Sheet data flows through the approval process based on a six-step status system and assignments previously entered into the company cost center (FIG. 15) and contract setup screens (FIGS. 6A-6D). The Expense Sheet (FIG. 4) is routed through the approval process based on each Line-Item/Charge-To cost center or project (405). Each Line-Item has it's own approval status (495) making it possible to have each individual manager approve their appropriate portion independently of the other managers. The system also “Exception Flags” (490) expenses for Billable expense items that have been changed to Non-Billable. These Billing changes might be appropriate, but the Exception Flag (490) ensures the reviewing manager does not overlook the billing change.

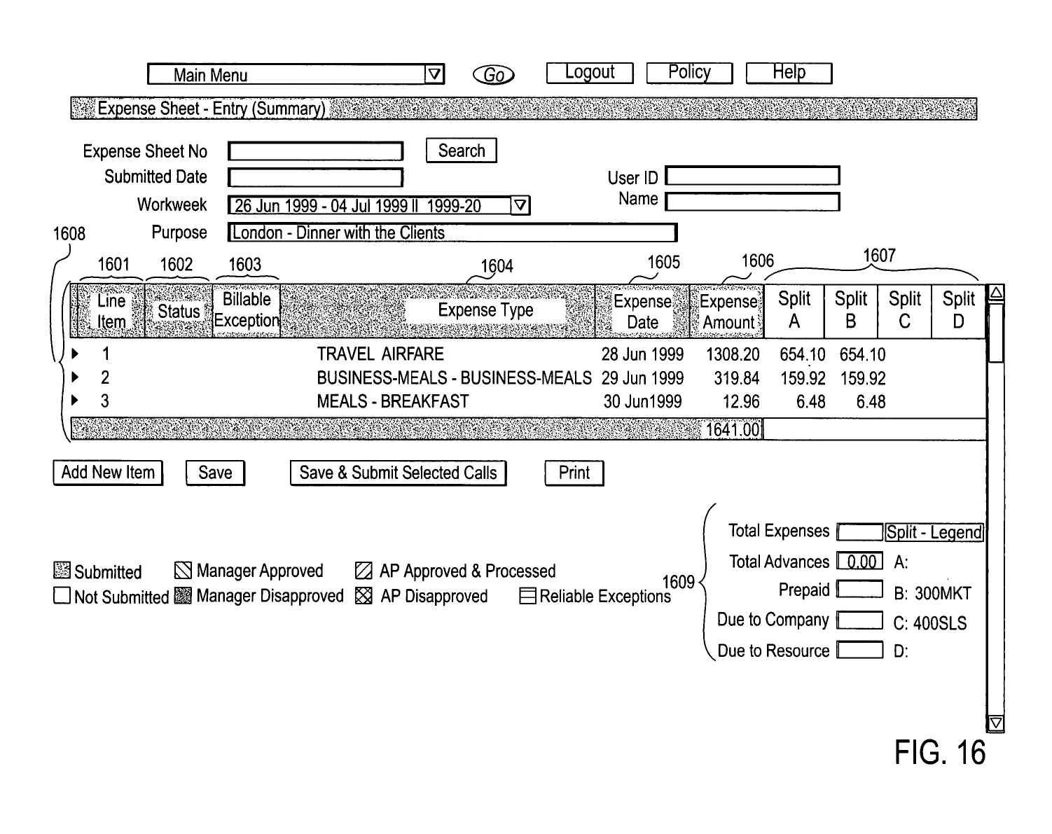

The approval process can be done at the Expense Sheet Line-Item summary level (FIG. 16), or at the most detailed level. Similar to the timesheet approval expense. approval/disapproval processing is done on an exception basis so that the manager(s) only needs to look at those specific costs for which approval action is required.

Referring to FIG. 9, workflow Flags (901) are provided on the system's main menu, just to the right of the particular screen title that needs to be used. This way, the resource or manager can quickly see the volume and types of actions required. Referring to FIG. 11B, notes (1150) are provided for each Expense Sheet line item (1154) and include inputs from the resource (1151), the approving manager (1152) and the Accounting Clerk (1153), facilitating cost justification and expense-disapproval communication. Also available is a system to quickly identify individuals who are late in submitting or approving Expense Sheets, and an automated email generation system to notify them of their outstanding actions as shown in FIG. 14.

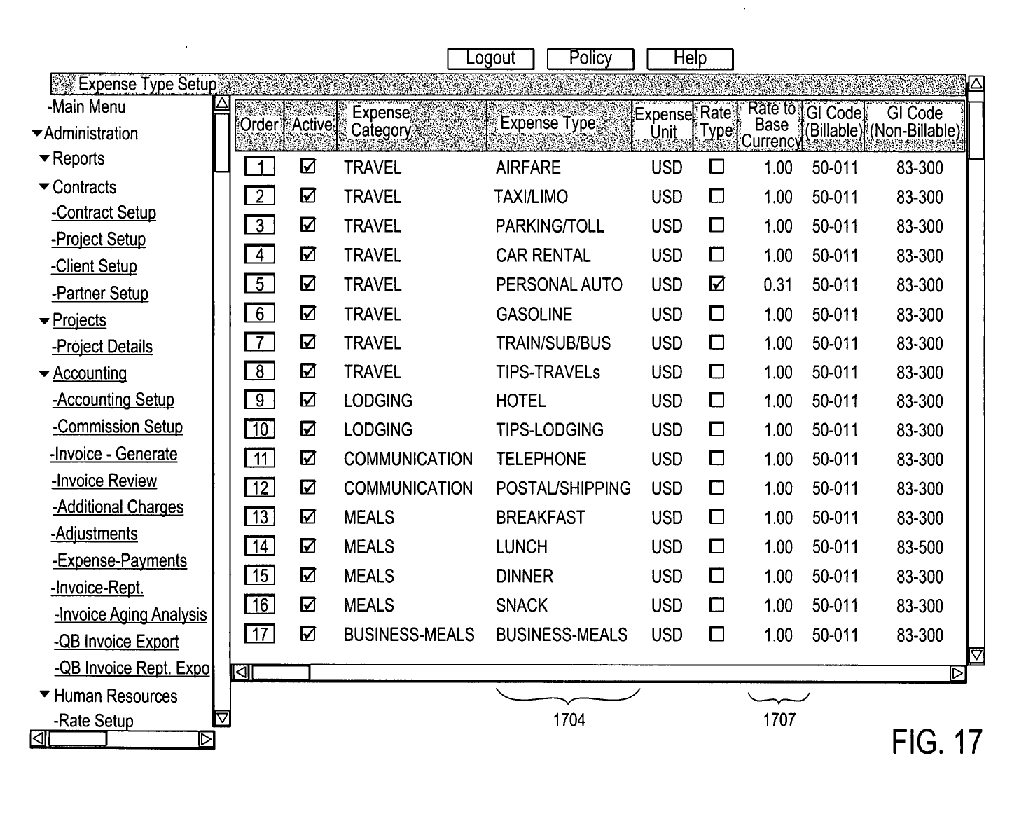

Referring to FIG. 17, accounting sets up the Expense Types (1704), Expense Categories (1703) and other expense accounting details in the Accounting Setup screen (FIG. 17). Through this screen Accounting can also remove or add Expense Types (1704) and Categories (1703), set the order in which they appear on the Expense Sheets and reports.

Accounting can also establish Rate Based Expense Types (1706), such as Personal Car Miles and the Reimbursement-Amount per mile (1707). Rate Based Expense Types (1706) can also be used for other expenses, such as meals in cases where the company has a preset value for such expense items.

To integrate the present system with the company's financial systems, the Accounting Setup screen also supports identification of the General Ledger Accounts (Billable and Non-Billable) for each Expense Type/Category. Thus, Accounting establishes much of how the Expense Sheet Entry screen and following calculation processes function.

Referring to FIG. 4, because most Expense entries are made through point and click selections from valid data lists, most Expense Sheet errors are avoided. In addition, the system ensures that all required data elements are present before allowing the completion of the Save process for each Line Item.

These pre-entered parameters also control post Expense Sheet entry processing. Expense Sheet data is routed for approval based on the company and contract parameters entered. Also, all cost and revenue calculations automatically include any maximum, minimum and not-to-exceed amounts.

Referring to FIG. 6D, an Expense Rule (6401) is selected for each Contract, as it is setup. The four Expense Rules are: Fixed, Reasonable, Not-To-Exceed/Person/Day and None. The Resources can enter actual expenses as they are incurred, but the Client Billing process automatically takes the Contract Expense Rules when calculating the Invoice Amounts. The approving manager may approve the entire expense amounts for Reimbursement, but the Invoices will always be per the Contractual parameters.

The Fixed Expense Rule utilizes the identification of an Event/Milestone, the Value, the Estimated Completion Date and, when it occurs, the Actual Completion Date. When the Actual Completion Date is entered, the system automatically generates the Expense Billable for invoicing. Because the Resources can continue to enter the actual Expenses for Reimbursement, Management will have the actual expense costs as well as the Client reimbursed revenue, for profit/loss analysis.

As described above, the system has a complete cost center system to aid tracking of non-project related expenses. Cost Centers are established and cost center managers are assigned. All Non-Project related expenses are routed to these cost center managers for approval.

The system supports features such as Splitting-Expenses across multiple Projects/Cost Centers, Foreign Currency Expenses, Payment Types (Resource Paid, Company Paid, Company Credit Card, and Client Pre-paid).

As described above in conjunction with FIG. 5, the Split Expenses across multiple Projects/Cost Centers allows an expense to be split across as many as four different projects (clients) and or Cost Centers. The split is made by entry of the monetary amount providing complete control to the system user. In the Expense Sheet Summary Screen (FIG. 16) the system shows the splits of all of the expenses, to which Project or Cost Center they are split and the dollar amounts, as well as summarizing the expenses by Project or Cost Center. Then the system routes the Expense Sheet to each of the Project Managers and Cost Center Managers for their approval. The approval screen displays all of the split-detail information to each of the approving managers.

Referring to FIG. 4, the system also provides four different payment types (420) for each expense: Resource Paid, Company Paid, Company Credit Card, and Client Pre-paid. By identifying the Payment Type (420) for each Expense (from the dropdown list with its default value from previously entered Line Items) the system calculates all billing and reimbursements. Referring to FIG. 16, as the Expense Sheet Line Items are entered, the system automatically calculates Total amounts for Expenses. Prepaid, Due to Company and Due to Resource (1609).

Because of the Split-Expense feature and the automatic routing for the manager(s) approval, the system is capable of managing all of a Resource's Expenses in a single weekly Expense Report. The system will support management policies requiring Expense Sheet entries be separated by project or trip and this is also supported.

The system routes the Expense Sheet to the appropriate approval manager(s) per the company and contract setup parameters, and also tracks the entry and approval routing per a six-step status system.

The six steps are: 1) Saved, 2) Submitted, 3) Manager Disapproved. 4) Manager Approved, 5) Accounting Disapproved, 6) Accounting Approved/Processed. Of course the disapproval steps are skipped unless the Expense Sheet line item is disapproved by the manager and/or client. The expenses are approved through two approval steps. In addition, the two Disapproved status levels are only used when a manager indicates it is needed.

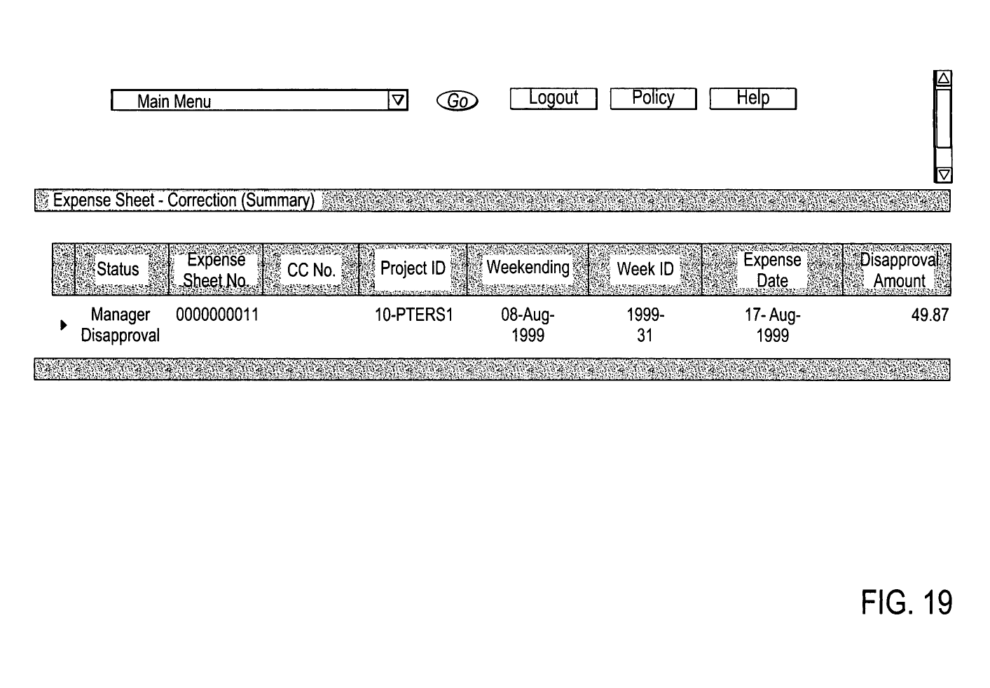

1) Saved Status—The saved status indicates the expense has been entered and saved to the database, but the resource has not submitted it for approval. This expense is not visible in the manager's approval screens. Saved expenses for prior workweeks (expenses late to be submitted) will be displayed in the main menu workflow numbers for the Resource's Expense Sheet-Correction screen (FIG. 19). The resource, can modify these line items.

2) Submitted Status—The submitted status indicates that the resource has entered the Expense Sheet data and submitted it for approval. The Expense Sheet's line items (401) flow to the appropriate manager's approval screen (FIG. 18) (project manager or expense center manager, and the accounting clerk) depending on what the expense's Charge-To settings (405) as identified during the expense entry process (FIG. 4). The resource can modify these submitted line items. The approval manager can change the status (approve or disapprove the line item), and add managerial notes (1152).

3) Manager Disapproved Status—The manager disapproved status indicates the line item(s) that were submitted by the resource and were disapproved by the manager. These expenses flow back to the resource's Expense Sheet-Correction screen (FIG. 19) for correction. The resource can modify these line items.

4) Manager Approved Status—The manager approved status indicates the line item(s) that were submitted by the resource and were approved by the manager. These line item(s) flow forward to the Accounting Clerk's approval screen for approval. Other than Notes, the status of these line items can be changed. and the Accounting Clerk can make the status change.

5) Accounting Clerk Disapproved Status—The Accounting Clerk disapproved status indicates line item(s) that were approved by the manager and then. were disapproved by the Accounting Clerk. This line item flows back to the manager's approval screen. Other than Notes, the status of these line items can be changed, and the manager can make the status change.

6) Accounting Approved/Processed—The Accounting Clerk approved status indicates the line item(s) that were approved by the manager and then approved by the Accounting Clerk. The expense is now available for invoice processing and cannot be changed by anyone. If changes in expenses and/or dollars are warranted, accounting can do an accounting adjustment through the Adjustment screen.

Referring to FIG. 16, to aid quick identification of an Expense Sheet's status. each line item (1601) on the Expense Sheet has a color status bar located toward the left of the line item row. Each expense sheet line item's color status bar (1602) displays the color associated with that line item's particular status. A user may see which line items require action. In addition, only those line items that require action will still contain a check box, which is located in the far left column of each line item row.

The Expense system automatically routes the expenses through the six-step approval process and also to the appropriate project or cost center manager, and the accounting clerk depending on the company and contract setup assignments.

Which manager approves the line item depends on the identified Charge-To (405) project or cost center. The particular project manager and accounting clerk required to do the project's expense approvals are identified through the project manager and accounts receivable assignment in the Project Setup screen (FIG. 7A) as the projects are entered. The particular cost center manager (1501) and accounts payable clerk (1502) are identified through the cost center manager and accounts payable clerk assignment in the Cost Center Setup screen (FIG. 15), usually during the initial system implementation or as these personnel are changed. These personnel assignments can be assigned to more than one manager (parallel assignment).

An expense sheet line item number (1601) uniquely defines each Resource's weekly Expense Sheet line item. In addition, the line item may be broken into more detailed sub-line items when multiple Charge-To's are identified, as is the case with a Split-Expense. Each expense line item, and any sub-line items it may contain, is routed to the appropriate approval manager(s). As each Expense Sheet's line item (401) is approved (this requires that all of the sub-line items must be approved before the line item is approved) the expense-sheet line item is routed to accounting for approval. The entire Expense Sheet need not complete approval for a particular expense line item to be Invoiced and/or Reimbursed.

Referring to FIG. 18, Expense Sheet line items (401) appear on the manager's approval screen (FIG. 18) as it becomes ready for review. The manager's Expense Sheet-Approval screen (FIG. 18) displays only those line items that he/she is assigned to review and approve or disapprove, based on the Charge-To (405) identification. Other than the Split-Expense line items, the project/cost center manager can approve a resource's Expense Sheet line item by simply checking the line item's checkbox (1803) in the Approval screen's summary grid (FIG. 18). The manager also has the option of drilling down and seeing the details of the resource's full Expense Sheet by clicking on the drill down arrows (1801) and then approving or disapproving at the line item level.

In the case of a Split-Expense, all of the sub-line items are also displayed so that the manager can see how the expense monetary amounts were distributed. At the same time, the approval project or cost center manager can only approve/disapprove the portion of the expense, the sub-line item, for which he/she is responsible.

As in the Expense Sheet Approval screen (FIG. 18) for the manager, described above, the Accounting Clerk's Expense Sheet-Approval screen displays only those expense-sheet line items that he/she is assigned to review and approve/disapprove. Expense Sheet line item data only appears on the Accounting Clerk's approval screen as it becomes ready for review.

The Accounting Clerk can approve a resource's line item (401) by simply checking the line item's checkbox in the Approval screen's summary grid similar to Timesheet approval illustrated in FIG. 13. The Accounting Clerk has the option of drilling down and seeing the details of all of the resource's expense line items for the Accounting Clerk's assigned projects/cost centers and then approving or disapproving them at the line item level.

When line items are disapproved, the Accounting Clerk adds an explanatory note (1153) to the project manager explaining what the problem is and what action should be taken. The Accounting Clerk Approved line items flow on to the final step in the approval process and are displayed in the Invoice Generation screen (FIG. 10).

The calculation of Expense Billables to be invoiced to the client is driven by the resource's Expense Sheet Screen (FIG. 4) entries, but is controlled by the Contract Setup screen parameters (FIGS. 6A-6D) entered for each contract. All of the Expense Billables are calculated before they reach accounting for invoicing,

All contracts are entered through the Contract Setup screen (FIGS. 6A-6D). and for each contract one of the four Expense Rules (6401), and an Invoice At Level (6303) are selected. Through these parameters, the system automatically identifies the expenses that can be billed and to what maximum monetary levels. Because the system does all of the billable calculations per the contract's parameters, expense invoices comply with contractual Limitations.

Accounting generates invoices for billable expenses. The system has a number of features that ensure invoice generation can be done quickly and rather error free. The accounting clerk only sees those billables that have been already been validated, completed the approval cycle and calculated per the dictates of the company and contract setup parameters. When the billables reach accounting they have already been keyed into the system, validated, and reviewed/approved by the appropriate managers. In addition, the system has already taken into account Accounting parameters such as a contractual Not-To-Exceed amount.

The accounting Invoice Generation screen (FIG. 10) provides filters to help select the outstanding billables to be invoiced: Accounting (all or specific), Charge Type (1002) (all, professional expense, expenses, additional charges) and From-To Dates (1004). Using these filters the user can generate a list of the billables to be combined into Invoices. A manual override is available in the form of a checkbox for each billable (1013). When the Generate Invoice button (1023) is selected, the system separates the billables by Accounting and then combines the individual billables into invoices depending on the Invoice At Level (6303) as set in either the Accounting Setup screen (FIG. 17) or the Contract Setup screen (FIGS. 6A-6D).

Referring to FIG. 11B, notes are available on-every Expense Sheet line item (401) and are used for the resource to annotate how expenses were spent and also to communicate problems/resolutions over disapproved expenses.

Each Expense Sheet line item (401) has the Expense Type (410), such as Travel and Airfare identified through the resource's selection in the dropdown list. The resource still has the opportunity to further identify justification or problems/observations by using the Notes button to the right of a particular Expense Sheet row.

The resource, manager or accounting clerk can enter notes as shown in FIG. 11B. These notes are kept separate and access to addition or modification of the particular user's notes is controlled by security. The resource, manager and accounting clerk can see all three sets of notes associated with the Expense Sheet row being addressed.

As discussed above with regard to timesheets, for expense management, in one embodiment, the system includes reports to identify late Expense Sheet submissions or approvals similar to the interface shown in FIG. 14. It also contains a semi-automated identification and email notification system so that emails can be efficiently sent to all resources or managers who are needed to submit or approve expense.

Whether for report generation or email notification, parameter windows are provided to help further identify the desired resources. For inadequate Expense Sheet submittal, resources are identified through entry into a filtering parameter window. The selection parameters include: 1) Workweek ID. and Resource.

For identifying managers and Accounting Clerks who need to approve expense, the managers are identified through entry into a filtering parameter window. The selection parameters include: 1) From Date, 2) To Date, and 3) All or a Specific Manager or Accounting Clerk.

If the parameter window is used to identify late Expense Sheet submissions to receive email notification, an additional selection process is available. The system displays the list of resources meeting the parameter window criteria and also displays a checkbox to the left of each resource's row. The checkbox can be used to remove more resources from the email-target list.

The email notification list window also contains the template of the text to be contained in the email's subject line and the body of the email. This text is entered through the administrative menu's Email Template screen. This template text can be edited for the particular emailing.

When the Send button is selected, the system generates a separate email to each of the selected resources, per the email address entered into their respective Resource Setup screen entries. If a Carbon Copy user email address was entered, the system will also send a copy of each of the resulting emails to that addressee. The requester will also receive an email in his/her email containing a summary list of the resources notified. A copy of this summary list may then be forwarded to an addressee as opposed to placing their email address in the carbon copy field and inundating them with all of the separate carbon copy emails.

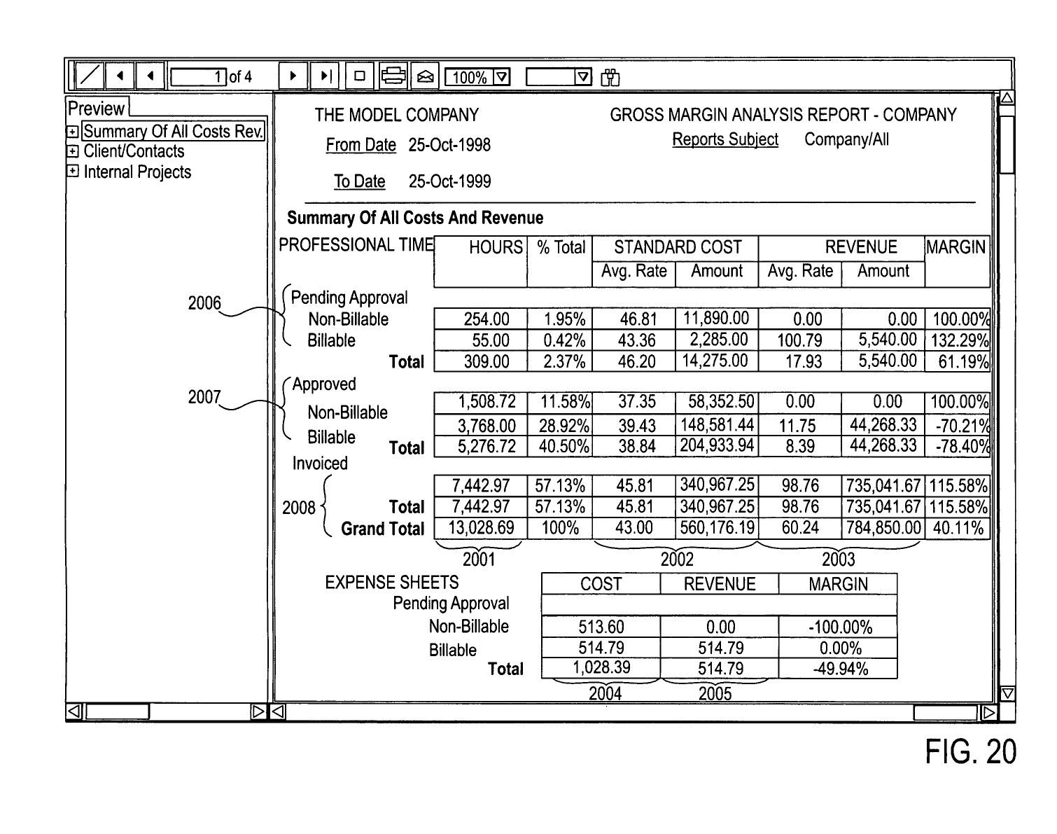

Referring to FIG. 20. multiple performance measurement options are available. The reports include hours (2001), costs (2002) and revenues (2003) for time and costs (2004) and revenues (2005) for expenses. This information is also broken into data that has been entered, (2006) approved (2007) or invoiced (2008).

The data is summarized for each project, contract and/or client. In addition the contracts can be assigned to three separate user-definable lists for summarization across contracts. Referring to FIG. 6A for example, contract performance might be reported by: type of practice (6109), sales region (6114) and client industry (6115).

The foregoing has described a system and method for contract based management of financial and time data. It is contemplated that changes and modifications may be made by one of ordinary skill in the art, to the materials and arrangements of elements of the present invention without departing from the scope of the invention.

1-11. (Cancelled)

12. A method of managing time and expense data associated with a contract, in a data processing system, said method comprising:
identifying a contract and its associated project(s);
accepting guidelines associated with the identified contract and its associated project(s);
receiving expense data corresponding to the contract and its associated project(s);
receiving time data corresponding to the contract and the projects(s);
routing the received expense data and time data to an approving authority responsible for determining whether the expense and/or time data is to be approved;
calculating billable costs associated with the received expense data and time data upon approval by the approving authority of the expense data and time data, wherein the billable costs are calculated according to the guidelines associated with the identified contract and its associated project(s); and
generating invoices corresponding to the calculated billable costs.

13. The computer-readable medium of claim 12 having stored thereon-additional instructions, said additional instructions when executed by a computer, cause said computer to perform the method of providing contract and project guidelines further comprising:
providing contract and project types;
providing contract and project status;
providing timesheet entry configurations;
providing expense sheet entry configurations;
providing timesheet approval configurations;
providing expense sheet approval configurations; and
providing expense rules.

14. The computer-readable medium of claim 12 having stored thereon-additional instructions, said additional instructions when executed by a computer, cause said computer to perform the method of providing contract and project guidelines further comprising:
providing resource assignments;
providing task assignments; and
providing manager assignments.

15. The computer-readable medium of claim 12 having stored thereon-additional instructions, said additional instructions when executed by a computer, cause said computer to perform the method of providing time data further comprising:
providing periodic time entries for a multitude of projects and contracts;
providing a type of time category selection; and
providing a class of work completed selection.

16. The computer-readable medium of claim 12 having stored thereon-additional instructions, said additional instructions when executed by a computer, cause said computer to perform the method of providing time data further comprising dividing time data into individual cells of time with an associated cell status and routing path.

17. The computer-readable medium of claim 12 having stored thereon-additional instructions, said additional instructions when executed by a computer, cause said computer to perform the method of providing expense data further comprising:
providing periodic expense entries for a plurality of projects and contracts;
providing expense types;
providing expense categories;
providing payment types;
providing foreign currency types; and
providing split-expenses.

18. The computer-readable medium of claim 12 having stored thereon-additional instructions, said additional instructions when executed by a computer, cause said computer to perform the method of providing expense data further comprising dividing expense data into individual cells of time with an associated cell status and routing path.

19. The computer-readable medium of claim 12 having stored thereon-additional instructions, said additional instructions when executed by a computer, cause said computer to further perform the method of generating invoices from approved expense and time data.

20. The computer-readable medium of claim 12 having stored thereon-additional instructions, said additional instructions when executed by a computer, cause said computer to further perform the method of generating financial analysis reports.

21-31. (Cancelled)

32. A carrier wave containing data from a data processing system, said carrier wave comprising:
contract and project guidelines;
expense data corresponding to the contract and project guidelines;
time data corresponding to the contract and project guidelines;
expense and time data analyzed corresponding to the contract and project guidelines;
expense routing data corresponding to the contract and project guidelines; and
time routing data corresponding to the contract and project guidelines.
